(19) United States
(12) Patent Application Publication
(10) Pub. No.: US 2005/0169501 A1
(43) Pub. Date: Aug. 4, 2005

(54) Method and apparatus for determining driving lane of vehicle, and computer product

(75) Inventors: Asako Fujii, Kawasaki (JP); Tomonobu Takashima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/935,313

(22) Filed: Sep. 8, 2004

(30) Foreign Application Priority Data
Jan. 29, 2004 (JP) 2004-021737

(51) Int. Cl. G06K 9/00

(52) U.S. Cl. 382/104

(57) ABSTRACT

A white line detector detects two white lines from predetermined regions of an image, and a region dividing unit uses the two white lines detected by the white line detector to divide the image into multiple regions. A luminance information acquiring unit calculates the luminance mean value of the respective regions divided into three by the region dividing unit, and the lane determining unit determines the driving lane by using the luminance mean value calculated by the luminance information acquiring unit.

### BACKGROUND OF THE INVENTION

1) Field of the Invention

The present invention relates to a technology for determining the driving lane of a vehicle.

2) Description of the Related Art

Car navigation systems those obtain and display a driving route between a current position and a destination of the vehicle have appeared in the market. These car navigation systems employ a digital map and the global positioning system (GPS) to decide the positions of the vehicles.

A car navigation system calculates the position of the vehicle (hereinafter, “own vehicle”), in which it is installed, based on the position data of the own vehicle obtained from the GPS, and displays the position on a digital map. The car navigation system can also vocally and/or visually inform the driving route to the driver of the own vehicle.

Moreover, the car navigation systems can tell the drivers to turn left or to turn right at an intersection. However, sometimes the driver can not take turns in the direction told by the system. For example, even if the system tells the driver to take a left turn, the driver can not take a left turn if there is a vehicle in a lane that is on the left. Similarly, even if the system tells the driver to take a right turn, the driver can not take a right turn if there is a vehicle in a lane that is on the right. Moreover, while driving straight, sometimes it is impossible to change lanes if there is a lane that is only for cars, or if the own vehicle is near an exit or a branch-off on a freeway.

Accordingly, a technique to determine the lane of the own vehicle has been demanded. Japanese Patent No. 2883131 discloses an approach to detect the lane. Image sensors are mounted on sides of the own vehicle so that those image sensors capture images of the road surface. The lane of the own vehicle is determined based on whether lane dividing lines in the images captured by the image sensor are solid lines or broken lines.

With the conventional technique it is not reliably possible to determine the lane; because, the road centerline may be a solid line or a broken line, moreover, the lane dividing lines may abruptly change from a solid line to a broken line or vice versa.

### SUMMARY OF THE INVENTION

It is an object of the present invention to provide a technique with which it is possible to reliably determine the lane.

A computer program according to an aspect of the present invention includes detecting a lane line on a road on which a vehicle is running by using an image captured by an image sensor mounted on the vehicle; dividing the image into a plurality of regions based on the lane line detected; and determining a lane in which the vehicle is running based on characteristics of the image in the regions.

A computer-readable recording medium according to another aspect of the present invention stores a computer program that causes a computer to execute detecting a lane line on a road on which a vehicle is running by using an image captured by an image sensor mounted on the vehicle; dividing the image into a plurality of regions based on the lane line detected; and determining a lane in which the vehicle is running based on characteristics of the image in the regions.

A driving lane determining apparatus according to still another aspect of the present invention includes a lane line detector that detects a lane line on a road on which a vehicle is running by using an image captured by an image sensor mounted on the vehicle; a region dividing unit that divides the image into a plurality of regions based on the lane line detected; and a driving lane determining unit that determines a lane in which the vehicle is running based on characteristics of the image in the regions.

A driving lane determining method according to still another aspect of the present invention includes detecting a lane line on a road on which a vehicle is running by using an image captured by an image sensor mounted on the vehicle; dividing the image into a plurality of regions based on the lane line detected; and determining a lane in which the vehicle is running based on characteristics of the image in the regions.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a driving lane determining apparatus according to a first embodiment of the present invention;

FIG. 2 depicts an example of contents of an image storage unit shown in FIG. 1;

FIGS. 3A to 3C are views for explaining a white line detection processing by a white line detector shown in FIG. 1;

FIG. 4 is a diagram for explaining a region division processing by a region dividing unit shown in FIG. 1;

FIG. 5 is a flowchart of the process procedure performed by the driving lane determining apparatus;

FIG. 6 is a flowchart of a white line detection processing shown in FIG. 5;

FIG. 7 is a flowchart of a region division processing shown in FIG. 5;

FIG. 8 is a flowchart of another example of the region division processing;

FIG. 9 is a flowchart of a luminance information acquisition processing shown in FIG. 5;

FIG. 10 is a flowchart of a driving lane determination processing shown in FIG. 5;

FIG. 11 is a functional block diagram of a driving lane determining apparatus according to a second embodiment of the present invention;

FIG. 12 is a flowchart of a driving lane determination processing by a lane determining unit shown in FIG. 12;

FIG. 13 is a functional block diagram of a driving lane determining apparatus according to a third embodiment of the present invention;

FIG. 14 is a flowchart of a driving lane determination processing by a lane determining unit shown in FIG. 13;

FIG. 15 is a functional block diagram of a driving lane determining apparatus according to a fourth embodiment of the present invention;

FIG. 16 is a flowchart of a driving lane determination processing by a lane determining unit shown in FIG. 15;

FIG. 17 is a functional block diagram of a driving lane determining apparatus according to a fifth embodiment of the present invention;

FIG. 18 is a flowchart of a driving lane determination processing by a lane determining unit shown in FIG. 17;

FIG. 19 is a functional block diagram of a driving lane determining apparatus according to a sixth embodiment of the present invention;

FIG. 20 is a flowchart of a driving lane determination processing by a lane determining unit shown in FIG. 19;

FIG. 21 is a functional block diagram of a driving lane determining apparatus according to a seventh embodiment of the present invention;

FIG. 22 is a flowchart of a driving lane determination processing by a lane determining unit shown in FIG. 21;

FIG. 23 is a functional block diagram of a driving lane determining apparatus according to an eighth embodiment of the present invention;

FIG. 24 is a flowchart of a driving lane determination processing by a lane determining unit shown in FIG. 23;

FIG. 25 is a functional block diagram of a driving lane determining apparatus according to a ninth embodiment of the present invention;

FIG. 26 is a flowchart of a driving lane determination processing by a lane determining unit shown in FIG. 25;

FIG. 27 is a functional block diagram of a driving lane determining apparatus according to a tenth embodiment of the present invention;

FIG. 28 is a flowchart of a driving lane determination processing by a lane determining unit shown in FIG. 27;

FIG. 29 is a functional block diagram of a driving lane. determining apparatus according to an eleventh embodiment of the present invention;

FIG. 30 is a flowchart of a driving lane determination processing by a lane determining unit shown in FIG. 29;

FIG. 31 is a functional block diagram of a driving lane determining apparatus according to a twelfth embodiment of the present invention;

FIG. 32 is a diagram for explaining an optical flow;

FIG. 33 is a diagram of an optical flow when there is no oncoming vehicle and/or adjacent parallel vehicle;

FIG. 34 is a diagram of an optical flow when there is an oncoming vehicle and/or an adjacent parallel vehicle;

FIG. 35 is a flowchart of a process procedure performed by a driving lane determining apparatus according to a twelfth embodiment of the present invention;

FIG. 36 is a flowchart of an oncoming vehicle detection processing shown in FIG. 35;

FIG. 37 is a flowchart of a driving lane determination processing shown in FIG. 35;

FIG. 38 is a functional block diagram of a driving lane determining apparatus according to a thirteenth embodiment of the present invention;

FIG. 39 is a flowchart of an adjacent parallel vehicle detection processing by an adjacent parallel vehicle detector shown in FIG. 38;

FIG. 40 is a flowchart of a driving lane determination processing by the lane determining unit shown in FIG. 38;

FIG. 41 is a functional block diagram of a driving lane determining apparatus according to a fourteenth embodiment of the present invention;

FIG. 42 is a flowchart of a driving lane determination processing by the lane determining unit shown in FIG. 41;

FIG. 43 is a functional block diagram of a driving lane determining apparatus according to a fifteenth embodiment of the present invention;

FIG. 44 is a flowchart of a driving lane determination processing by a lane determining unit shown in FIG. 43;

FIG. 45 is a functional block diagram of a driving lane determining apparatus according to a sixteenth embodiment of the present invention;

FIG. 46 is a flowchart of a driving lane determination processing by a lane determining unit shown in FIG. 45;

FIG. 47 is a functional block diagram of a driving lane determining apparatus according to a seventeenth embodiment of the present invention;

FIG. 48 is a flowchart of a driving lane determination processing by a lane determining unit shown in FIG. 47;

FIG. 49 is a functional block diagram of a driving lane determining apparatus according to an eighteenth embodiment of the present invention;

FIGS. 50A to 50C are views for explaining how a shift amount calculator shown in FIG. 49 calculates a shift amount;

FIG. 51 is a flowchart of a process procedure performed by the driving lane determining apparatus according to the eighteenth embodiment of the present invention;

FIG. 52 is a flowchart of a shift amount calculation processing shown in FIG. 51;

FIG. 53 is a flowchart of a depression angle calculation processing by a depression angle calculator shown in FIG. 49;

FIG. 54 is a flowchart of an oncoming vehicle detection processing shown in FIG. 51;

FIG. 55 is a functional block diagram of a driving lane determining apparatus according to a nineteenth embodiment of the present invention;

FIG. 56 is a flowchart of an adjacent parallel vehicle detection processing by the adjacent parallel vehicle detector shown in FIG. 55; and

FIG. 57 is a schematic of a computer that executes a computer program that realizes the first to the nineteenth embodiments.

### DETAILED DESCRIPTION

Exemplary embodiments of a computer program, a recording medium, a driving lane determining apparatus, and a driving lane determination method according to the present invention will be explained in detail with reference to the accompanying drawings.

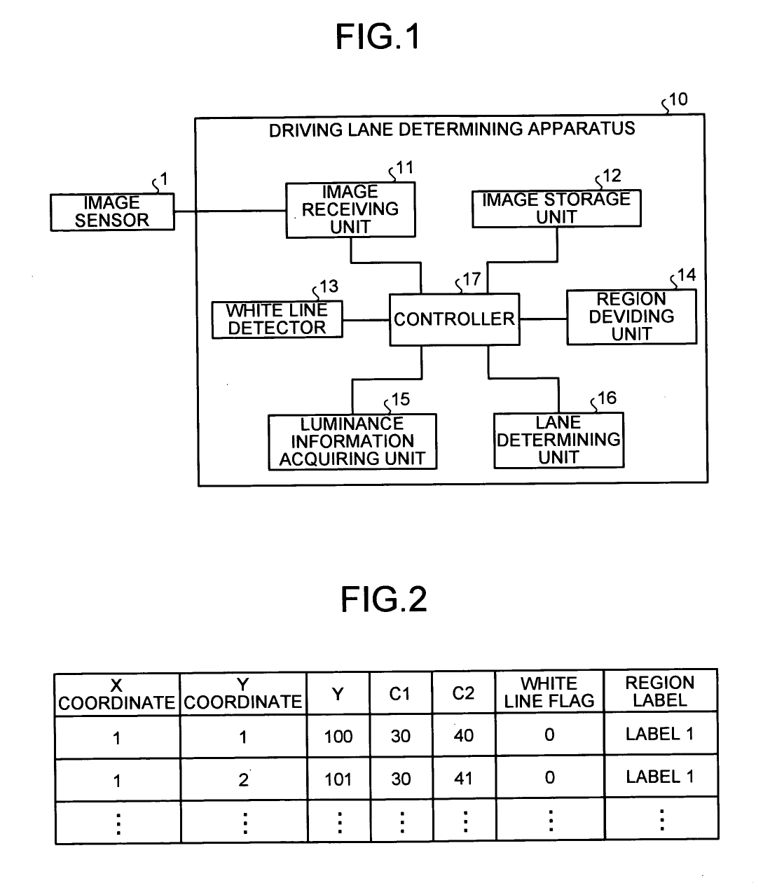

FIG. 1 is a functional block diagram of a driving lane determining apparatus 10 according to a first embodiment. The driving lane determining apparatus 10 include an image receiving unit 11, an image storage unit 12, a white line detector 13, a region dividing unit 14, a luminance information acquiring unit 15, a lane determining unit 16, and a controller 17.

An image sensor 1 is installed in front of a own vehicle in such a manner that lane lines on two sides of the own vehicle can be captured. The image captured by the image sensor 1 is input into the image receiving unit 11. The image receiving unit 11 stores the image in the image storage unit 12.

This embodiment assumes that an image sensor installed on the front of the own vehicle captures an image of the lane lines on two sides of the own vehicle. However, one image sensor may be installed on each side of the own vehicle to capture an image of corresponding lane line.

The image sensor 1 may be black-and-white or color. Moreover, instead of installing the image sensor 1 on the front side, it may be installed at the rear of the own vehicle.

The image storage unit 12 stores the images and image processing results by the driving lane determining apparatus 10. FIG. 2 depicts an example of contents of the image storage unit 12. The image storage unit 12 stores an x coordinate, a y coordinate, a luminance (Y), color difference information (C1, C2), a white line flag, and a region label, for each pixel in the image.

The white line flag is a flag that indicates whether each pixel belongs to the white line that indicates the lane line. When the pixel belongs to the white line, the white line flag is set to “1”, and when the pixel does not belong to the white line, the white line flag is set to “0”. The region label indicates a label number of a region in the image divided by the white line, and takes any one value of from “label 0” to “label 3”.

For example, in FIG. 2, in a pixel in which the x coordinate is “1”, and the y coordinate is “1”, the luminance (Y) is “100”, and the color difference information (C1, C2) is “(30, 40)”, and since the pixel does not belong to the white line the white flag is “0”, and hence the region label is “label 1”.

The x coordinate, the y coordinate, the luminance (Y), and the color difference information (C1, C2) are information input by the image receiving unit 11, and the white line flag and the region label are information obtained as the processing result by the driving lane determining apparatus 10.

The luminance (Y) and the color difference information (C1, C2) are used herein as the information of each pixel, however, red (R), green (G), and blue (B), or hue (H), color saturation (S), and luminance (V) may be used instead. Incidentally, YC1C2, RGB, and HSV can be expressed according to the following relation.
Y=rR+gG+bB (r, g, and b are predetermined values)
C1=Y−R, C2=Y−B
C1=S·sin(H), C2=S cos(H)

The information excluding the luminance information, that is, the information of the hue H, the color saturation S, and the color difference C1, C2 is the color information.

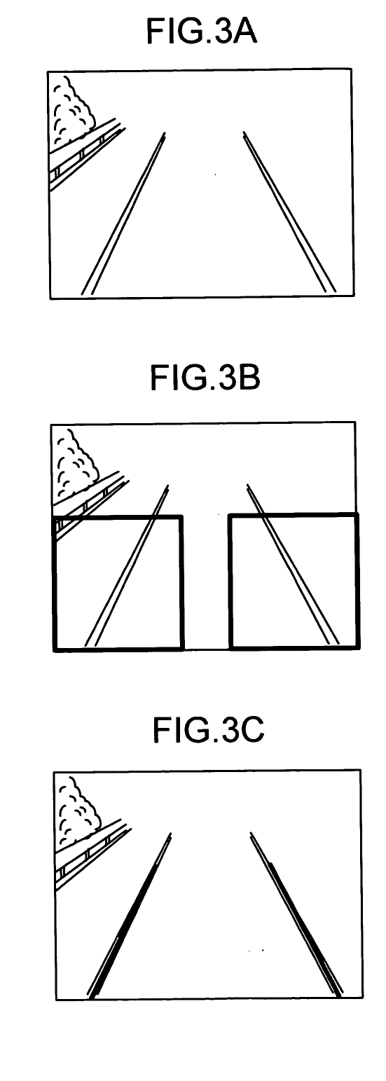

The white line detector 13 detects white lines on the sides of the own vehicle in an image stored in the image storage unit 12. FIGS. 3A to 3C are views for explaining a white line detection processing performed by the white line detector 13.

FIG. 3A is a schematic of a road surface with road lanes and white lines. The white line detector 13 detects, as shown in FIG. 3B, whether there is any white line in a predetermined region. That is, the white line detector 13 presets a region for detecting the white line at the left end of the driving lane of the own vehicle, and a region for detecting the white line at the right end.

In each preset region, a differential filter is applied. For the differential filter, a differential filter such as a Laplacian filter or a Sobel filter may be used. When it is assumed that an input image is f(x, y), and an output image is g(x, y), in the Laplacian filter, an output image g(x, y) is calculated as described below.

$$\begin{matrix}g ( i , j ) = {0}^{*} f ( i - 1 , j - 1 ) + {1}^{*} f ( i , j - 1 ) + {0}^{*} f ( i + 1 , j - 1 ) + \\ {1}^{*} f ( i - 1 , j ) - {4}^{*} f ( i , j ) + {1}^{*} f ( i + 1 , j ) + \\ {0}^{*} f ( i - 1 , j + 1 ) + {1}^{*} f ( i , j + 1 ) + {0}^{*} f ( i + 1 , j + 1 )\end{matrix}$$

where i and j denote the x and y coordinates in the image.

The result of the differential filter is then binarized by a predetermined threshold. When it is assumed that the white line to be detected is a straight line, a straight line is detected one each from each region. As a representative method generally used for detecting a straight line, there are a Hough transform and a method of least squares. The Hough transform is used for detecting the straight line. The following equation is used for the Hough transform:
ρ=xcosθ+ysinθ.

The white line detector 13 projects a pixel (x, y) having “1” as a result of binarization in a ρ-θ space. When a straight line is projected, it is expressed in dots in the ρ-θ space. Therefore, a point having the largest number of projection is detected as a straight line, which is designated as the white line detection result. An example of the white line detected in this manner is shown in FIG. 3C.

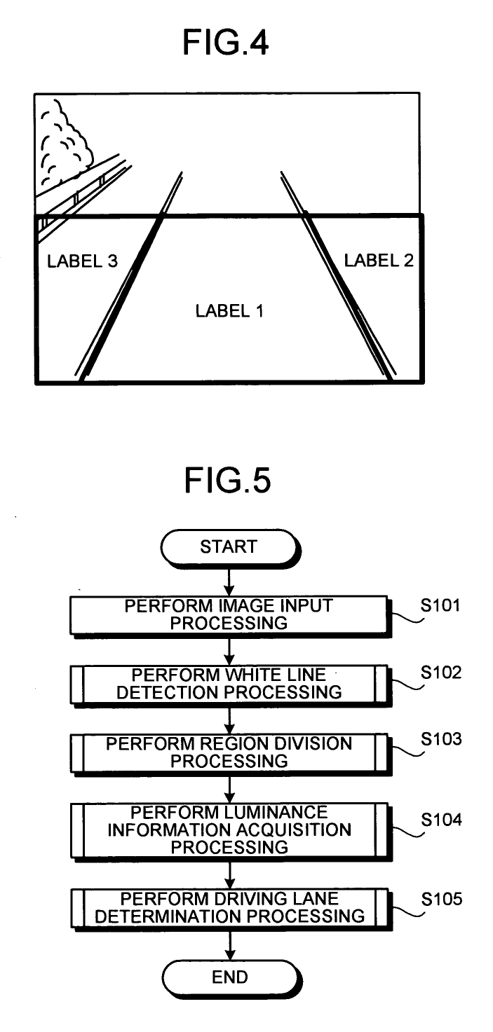

The region dividing unit 14 uses the white lines detected by the white line detector 13 to divide the predetermined region in the image. FIG. 4 is a diagram for explaining a region division processing by the region dividing unit 14.

As shown in FIG. 4, the region dividing unit 14 attaches a “label 1” to a region between the detected two white lines as a driving lane region. Moreover, the region dividing unit 14 attaches a “label 2” to the right region of the right white line, and attaches a “label 3” to the left region of the left white line.

The luminance information acquiring unit 15 calculates a mean value of the luminance information in each region labeled as “label 1”, “label 2”, and “label 3”. The mean value is obtained by dividing the sum of the luminance in pixels belonging to the respective regions by the area of the region.

The lane determining unit 16 compares the luminance mean value in the driving region (the region of “label 1”) of the own vehicle with the luminance mean value in the right region (the region of “label 2”) and the left region (the region of “label 3”), to determine whether the left and right regions are the shoulder of the road or an adjacent lane.

For example, as shown in FIG. 3A, when the right region is an adjacent lane, and the left region is the shoulder of the road, the difference in the luminance between the region of “label 1” and the region of “label 2” is small, and the difference in the luminance between the region of “label 1” and the region of “label 3” is large. Therefore, it can be determined whether the adjacent region is the shoulder or the lane, depending on whether the difference between the luminance mean value of the adjacent region and the luminance mean value of the driving region is larger or smaller than a predetermined value.

Since the lane determining unit 16 determines whether the adjacent region is the shoulder or the lane, by using the luminance information calculated by the luminance information acquiring unit 15, the driving lane determining apparatus 10 can determine the driving lane.

The controller 17 controls the whole driving lane determining apparatus 10. Specifically, the controller 17 performs control shift amount between functional units and data transfer between the functional units and the storage unit, thereby allowing the driving lane determining apparatus 10 to function as one apparatus.

The process procedure performed by the driving lane determining apparatus 10 will be explained with reference to FIG. 5. The driving lane determining apparatus 10 performs an image input processing, in which the image receiving unit 11 receives image information from the image sensor 1 and stores the image in the image storage unit 12 (step S101).

The driving lane determining apparatus 10 then performs the white line detection processing, in which the white line detector 13 uses the image information stored in the image storage unit 12 to detect two white lines (step S102), and the region division processing, in which the region dividing unit 14 uses the two white lines detected by the white line detector 13 to divide a predetermined image area into three regions (step S103).

The driving lane determining apparatus 10 then performs a luminance information acquisition processing, in which the luminance information acquiring unit 15 calculates a luminance mean value of each region divided into three by the region dividing unit 14 (step S104), and a driving lane determination processing, in which the lane determining unit 16 determines the driving lane by using the luminance mean value calculated by the luminance information acquiring unit 15 (step S105).

Since the lane determining unit 16 determines the driving lane by using the luminance in the region divided by the white lines, the driving lane determining apparatus 10 can determine the driving lane, regardless of the lane line being a solid line or a broken line.

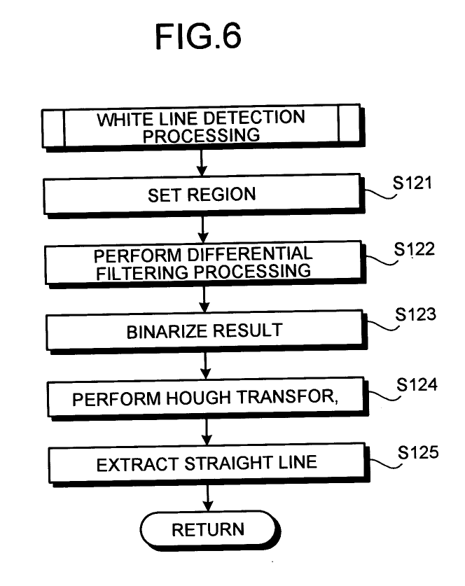

The white line detection processing (step S102) shown in FIG. 5 will be explained with reference to FIG. 6. The white line detection processing is performed by the white line detector 13.

As shown in FIG. 6, in the white line detection processing, a region in which a white line is to be detected is set (step S121), and a differential filtering processing is performed with respect to the pixels in the set region (step S122). The result of the differential filtering processing is binarized (step S123), and Hough transform is performed with respect to a pixel having a value “1” as a result of binarization (step S124). A straight line is then extracted based on the Hough transform result (step S125).

In the white line detection processing, the lane line can be detected accurately, by performing the differential filtering processing, binarization, and Hough transform with respect to the pixels included in the predetermined region.

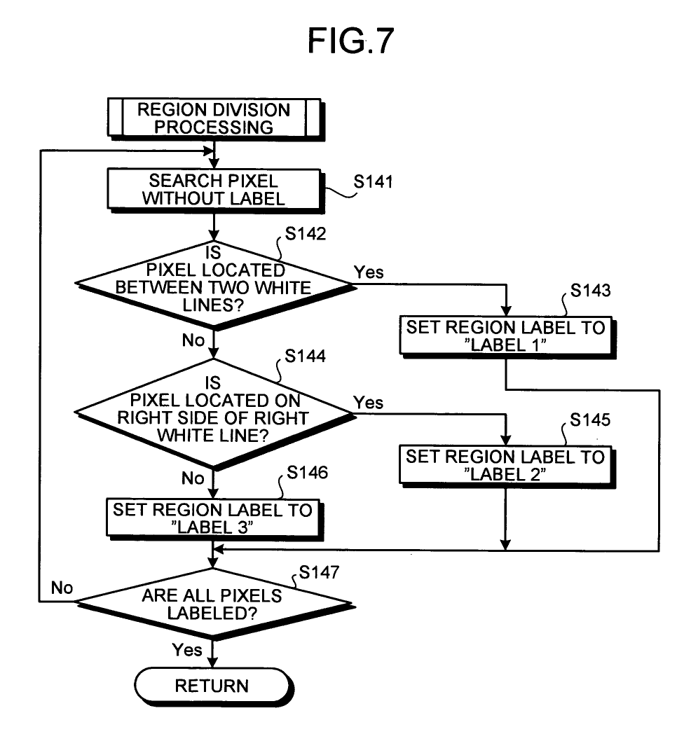

The region division processing (step S103) shown in FIG. 5 will be explained with reference to FIG. 7. The region division processing is performed by the region dividing unit 14.

As shown in FIG. 7, in the region division processing, one pixel without a label is selected (step S141), to determine whether the selected pixel is located between two white lines (step S142).

As a result, if the selected pixel is located between two white lines, the region label for the pixel is set to “label 1” and written in the image storage unit 12 (step S143). On the other hand, if the selected pixel is not located between two white lines, it is then determined whether the pixel is located on the right side of the right white line (step S144).

As a result, if the pixel is located on the right side of the right white line, the region label therefor is set to “label 2”, and written in the image storage unit 12 (step S145), and if the pixel is not located on the right side of the right white line, the region label therefor is set to “label 3”, and written in the image storage unit 12 (step S146).

It is then determined whether all pixels are labeled (step S147). If all the pixels are not labeled, control returns to step S141 to attach labels to other pixels, and if all the pixels are labeled, the processing is finished.

Thus, in the region division processing, by determining the positions of respective pixels with respect to the two white lines, the predetermined image area can be divided into three regions.

The driving lane determining apparatus 10 compares the information of the road surface in the own lane and the information of the road surface in the adjacent lane, to determine the driving lane for the own vehicle. However, when there is a vehicle in front of the own vehicle, the information of the vehicle in front may be included in the comparison object as the information of the road surface in the own driving lane.

Therefore, the region division processing, in which a region with high color saturation is labeled as “label 0”, by utilizing the fact that the color saturation on the road surface is generally low, however, vehicles are coated with a paint having high color saturation, so that the information of the vehicle in front is not included in the information of the driving lane region, will be explained.

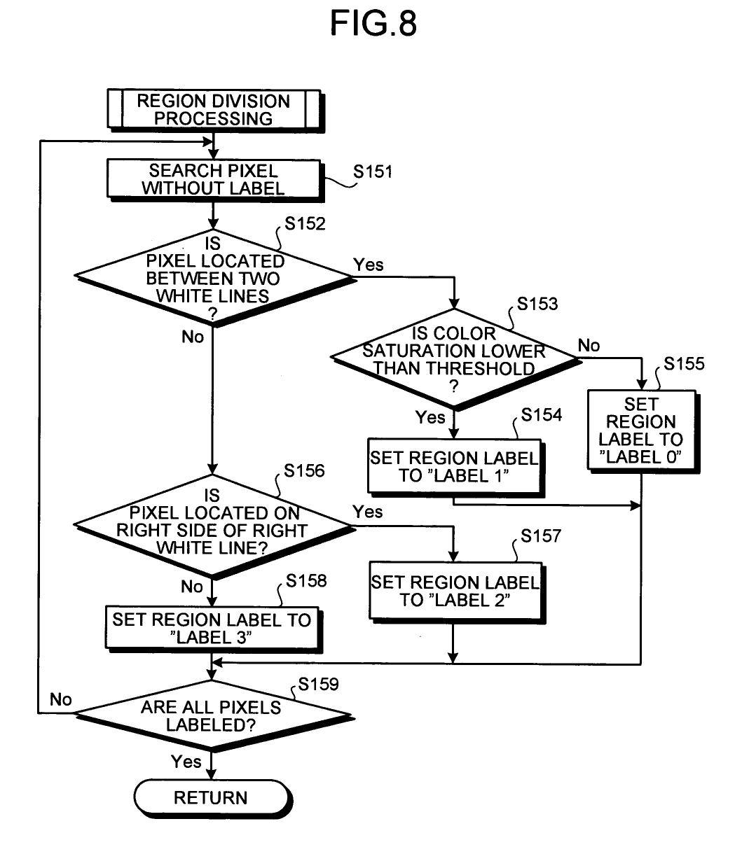

FIG. 8 is a flowchart of the region division processing, in which the information of the vehicle in front is not included in the information of the driving lane region. In the region division processing, a pixel that has not been labeled is selected (step S151) to determine whether the pixel is located between two white lines (step S152).

If the pixel is located between two white lines, it is determined whether the color saturation in the pixel is lower than a predetermined threshold (step S153). If the color saturation in the pixel is lower than the threshold, the region label for the pixel is set to “label 1” and written in the image storage unit 12 (step S154). If the color saturation in the pixel is not lower than the threshold, it is determined that the pixel is for a vehicle in front, and the region label for the pixel is set to “label 0” and written in the image storage unit 12 (step S155).

On the other hand, if the pixel is not located between two white lines, it is then determined whether the pixel is located on the right side of a right white line (step S156). If the pixel is located on the right side, the region label therefor is set to “label 2”, and written in the image storage unit 12 (step S157). If the pixel is not located on the right side, the region label is set to “label 3”, and written in the image storage unit 12 (step S158).

It is then determined whether all pixels are labeled (step S159). If all the pixels are not labeled, control returns to step S151 to attach labels to other pixels. If all the pixels are labeled, the processing is finished.

Thus, in the region division processing, by determining whether the color saturation in the pixel is lower than the predetermined threshold with respect to pixels included in the driving lane region, the region of the vehicle in front can be excluded as being interpreted as the driving lane region.

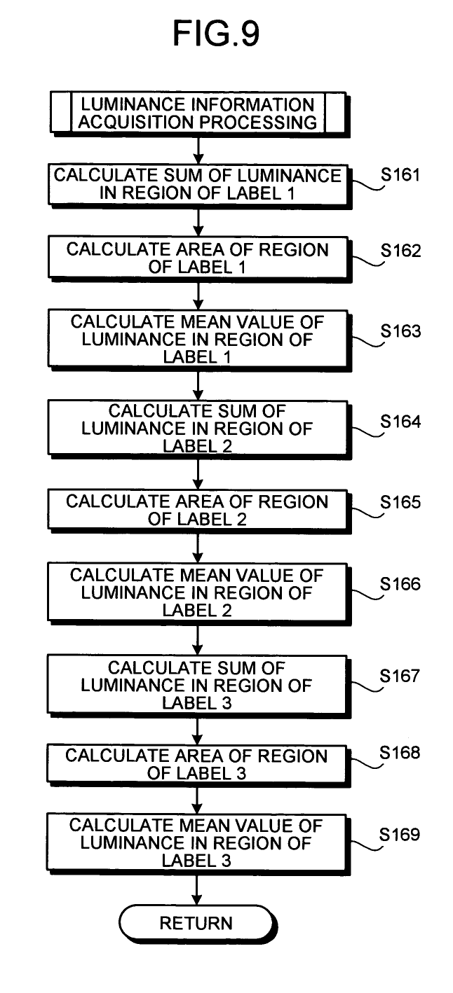

The luminance information acquisition processing (step S104) shown in FIG. 5 will be explained with reference to FIG. 9. The luminance information acquisition processing is performed by the luminance information acquiring unit 15.

In the luminance information acquisition processing, the sum of luminance in the region labeled as “label 1” and the area thereof are calculated (step S161 to step S162), and the sum of luminance is divided by the area to calculate the mean value of the luminance in the region labeled as “label 1” (step S163).

Likewise, the sum of luminance in the region labeled as “label 2” and the area thereof are calculated (step S164 to step S165), and the sum of luminance is divided by the area to calculate the mean value of the luminance in the region labeled as “label 2” (step S166).

Likewise, the sum of luminance in the region labeled as “label 3” and the area thereof are calculated (step S167 to step S168), and the sum of luminance is divided by the area to calculate the mean value of the luminance in the region labeled as “label 3” (step S169).

Thus, in the luminance information acquisition processing, the sum of luminance and the area are calculated for each region labeled as “label 1” to “label 3”, and the sum of luminance is divided by the area to calculate the mean value.

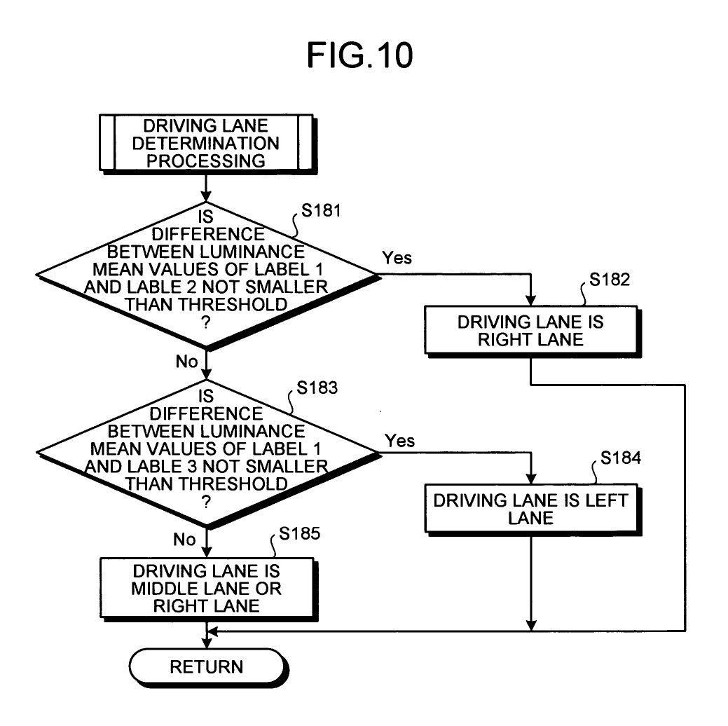

The driving lane determination processing (step S105) shown in FIG. 5 will be explained with reference to FIG. 10. The driving lane determination processing is performed by the lane determining unit 16.

In the driving lane determination processing it is determined whether a difference between the luminance mean value of the region labeled as “label 1” and the luminance mean value of the region labeled as “label 2” is not smaller than a threshold (step S181), and when the difference is not smaller than the threshold, since the situation on the road surface in the right side region is different from that of the driving lane, it is determined that the driving lane is the right lane (step S182).

On the other hand, when the difference between the luminance mean value of the region labeled as “label 1” and the luminance mean value of the region labeled as “label 2” is smaller than the threshold, it is then determined whether a difference between the luminance mean value of the region labeled as “label 1” and the luminance mean value of the region labeled as “label 3” is not smaller than a threshold (step S183), and when the difference is not smaller than the threshold, since the situation on the road surface in the left side region is different from that of the driving lane, it is determined that the driving lane is the left lane (step S184).

On the other hand, when the difference between the luminance mean value of the region labeled as “label 1” and the luminance mean value of the region labeled as “label 3” is smaller than the threshold, since both right and left sides are lanes, it is determined that the driving lane is the middle lane or the right lane (step S185).

Thus, the driving lane is determined by determining whether the luminance mean value of the driving lane region and the luminance mean value of the right and left regions are not smaller than a threshold.

In the first embodiment, the white line detector 13 detects two white lines from the predetermined region of the image, and the region dividing unit 14 uses the detected white lines to divide the image into multiple regions. The luminance information acquiring unit 15 calculates the luminance mean value of the respective regions divided into three by the region dividing unit 14, and the lane determining unit 16 determines the driving lane by using the luminance mean value calculated by the luminance information acquiring unit 15. As a result, the driving lane can be determined regardless of whether the lane line is a solid line or a broken line.

In the first embodiment, an example in which the driving lane is determined by using the luminance information of the image has been explained. However, color information may be used instead of the luminance information. In a second embodiment described below, a driving lane determining apparatus that determines the driving lane by using the color information will be explained.

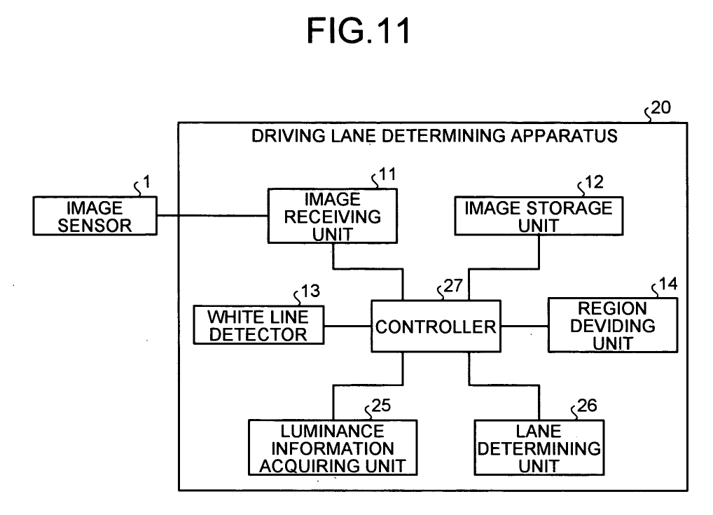

FIG. 11 is a functional block diagram of a driving lane determining apparatus 20 according to the second embodiment. For convenience, the functional units performing like roles as those of the respective units shown in FIG. 1 are designated by like reference signs, and the detailed explanation thereof is omitted.

The driving lane determining apparatus 20 includes the image receiving unit 11, the image storage unit 12, the white line detector 13, the region dividing unit 14, a color information acquiring unit 25, a lane determining unit 26, and a controller 27 that controls the whole driving lane determining apparatus 20.

The color information acquiring unit 25 calculates a mean value of color differences (C1, C2) between respective regions in the image divided by the region dividing unit 14. Since the road surface is generally monotonous, the color saturation is low. On the other hand, portions other than the road surface are not monotonous, and may have high color saturation. The driving lane determining apparatus 20 uses this characteristic of the road surface, to determine the road surface and the shoulder.

The color information acquiring unit 25 then calculates a mean value of the color difference (C1, C2), as the color information of the respective regions in the image divided by the region dividing unit 14. The calculation of the mean value is performed as in the calculation of the luminance information.

The lane determining unit 26 uses the mean value of the color difference calculated by the color information acquiring unit 25 to determine the driving lane. Specifically, the lane determining unit 26 compares the regions labeled as “label 1”, “label 2”, and “label 3” by using a distance D of a mean value of the color difference (C1, C2) between two regions as an amount of characteristic, to determine the driving lane of the own vehicle.

When it is assumed that a mean value of the color difference in a region of label a is designated as (C1a, C2a), and a mean value of the color difference in a region of label b is designated as (C1b, C2b), the distance Dab is calculated using:
D_{ab}=\sqrt{(C1a−C1b)²+(C2a−C2b)²} (1)

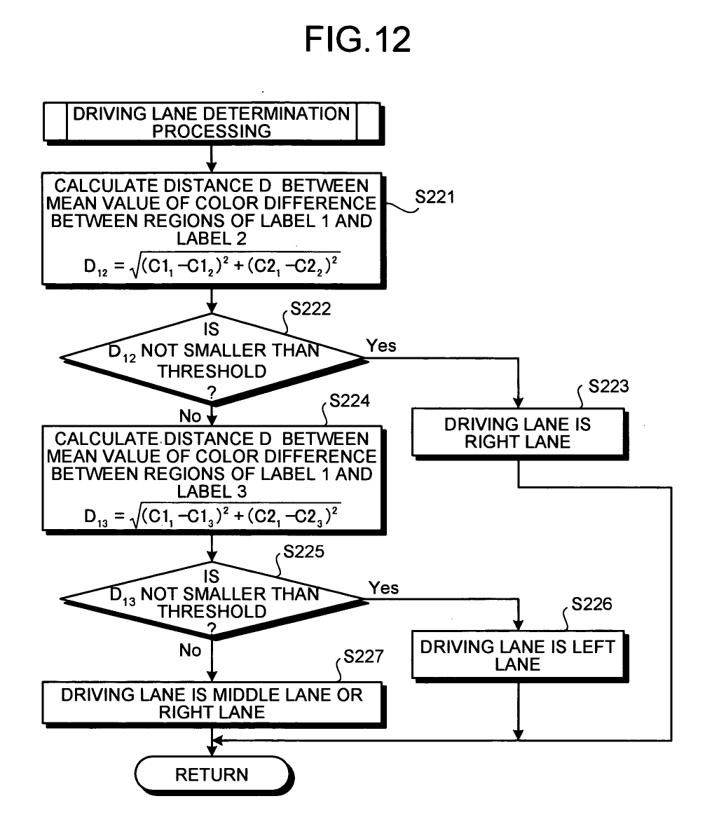

A driving lane determination processing performed by the lane determining unit 26 will be explained with reference to FIG. 12. The lane determining unit 26 calculates a distance D₁₂ of a mean value of the color difference between regions of “label 1” and “label 2” (step S221).

The lane determining unit 26 then determines whether the calculated distance D₁₂ is not smaller than a predetermined threshold (step S222), and when the distance D₁₂ is not smaller than the threshold, since the situation on the road surface in the right side region is different from that of the driving lane, determines that the driving lane is the right lane (step S223).

On the other hand, when the distance D₁₂ is smaller than the threshold, the lane determining unit 26 calculates a distance D₁₃ of a mean value of the color difference between regions of “label 1” and “label 3” (step S224). The lane determining unit 26 then determines whether the calculated distance D₁₃ is not smaller than the threshold (step S225), and when the distance D₁₃ is not smaller than the threshold, since the situation on the road surface in the left side region is different from that of the driving lane, determines that the driving lane is the left lane (step S226).

On the other hand, when the calculated distance D₁₃ is smaller than the threshold, since both the right and left sides are lanes, the lane determining unit 26 determines that the driving lane is the middle lane or the right lane (step S227).

In this manner, the lane determining unit 26 calculates the distance D of the mean value of the color difference between the driving lane region and the right and left regions and determines whether the calculated distance D is smaller than the threshold to determine the driving lane.

In the second embodiment, the color information acquiring unit 25 calculates color difference mean values between respective regions divided into three by the region dividing unit 14, and the lane determining unit 26 determines the driving lane by using the distance between the color difference mean values calculated by the color information acquiring unit 25. As a result, the driving lane can be determined regardless of the lane line being a solid line or a broken line.

In the first embodiment, an example in which the driving lane is determined by using the luminance information has been explained, and in the second embodiment, an example in which the driving lane is determined by using the color information has been explained. However, the driving lane can be determined by using both the luminance information and the color information. In a third embodiment, a driving lane determining apparatus that determines the driving lane by using both the luminance information and the color information will be explained.

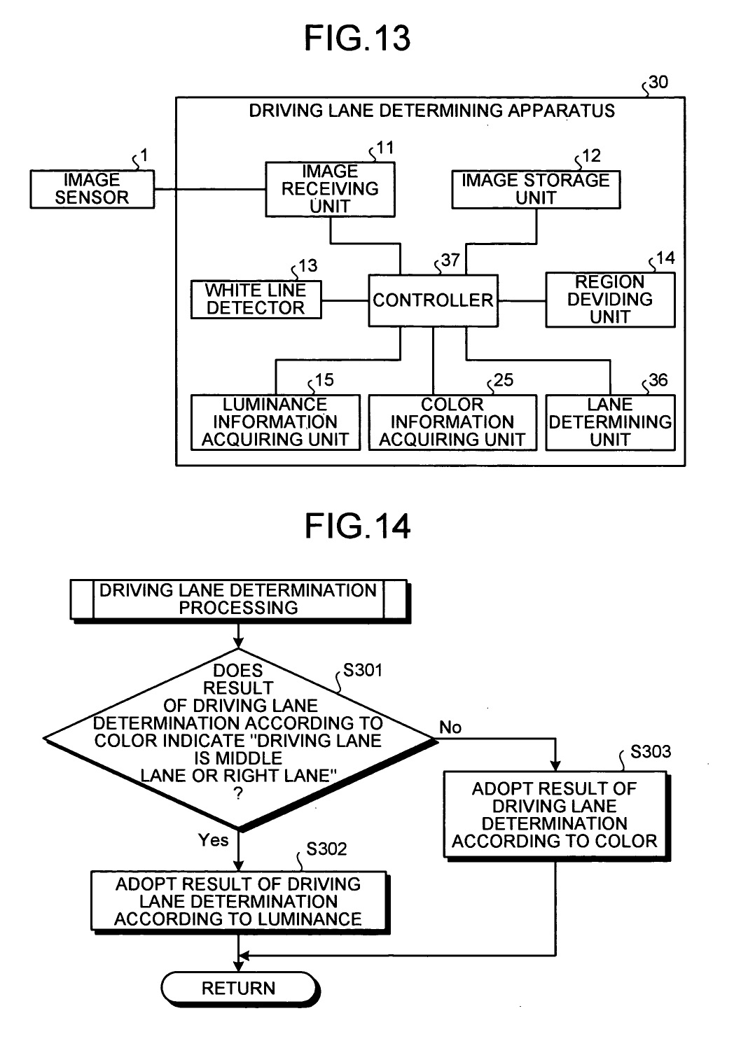

FIG. 13 is a functional block diagram of a driving lane determining apparatus 30 according to the third embodiment. For convenience, the functional units performing like roles as those of the respective units shown in FIG. 1 or FIG. 11 are designated by like reference signs, and the detailed explanation thereof is omitted.

The driving lane determining apparatus 30 includes the image receiving unit 11, the image storage unit 12, the white line detector 13, the region dividing unit 14, the luminance information acquiring unit 15, the color information acquiring unit 25, the lane determining unit 36, and a controller 37 that controls the whole driving lane determining apparatus 30.

In other words, the driving lane determining apparatus 30 has both the luminance information acquiring unit 15 that calculates a luminance mean value in each region divided into three by the region dividing unit 14, and the color information acquiring unit 25 that calculates a mean value of the color difference (C1, C2) in the respective regions.

The lane determining unit 36 determines the driving lane by using both the luminance mean value calculated by the luminance information acquiring unit 15, and the mean value of the color difference calculated by the color information acquiring unit 25. Since the lane determining unit 36 uses both the luminance and the color information for driving lane determination, accurate determination can be performed, even when adequate determination cannot be performed with the driving lane determination using the individual information.

For example, even when the region on the shoulder of the road is monotonous as on the road surface, when the luminance is considerably higher than that of the road surface, the shoulder cannot be determined only by the determination according to color, however, can be determined by the luminance.

A driving lane determination processing by the lane determining unit 36 will be explained with reference to FIG. 14. The lane determining unit 36 performs determination of the driving lane according to the color, to determine whether the determination result indicates that “the driving lane is the middle lane or the right lane” (step S301).

When the determination result according to the color indicates that “the driving lane is the middle lane or the right lane”, the lane determining unit 36 performs determination of the driving lane according to the luminance, and adopts the result thereof as the driving lane determination result (step S302). When the determination result according to the color does not indicate that “the driving lane is the middle lane or the right lane”, the lane determining unit 36 adopts the determination result according to the color as the driving lane determination result (step S303).

Thus, the lane determining unit 36 preferentially adopts the determination according to the color information, and when the determination result according to the color indicates that “the driving lane is the middle lane or the right lane”, that is, when the shoulder of the road cannot be found according to the color information, the lane determining unit 36 adopts the determination result according to the luminance information. As a result, when determination according to the color information is not clear, determination according to the luminance information can support the determination.

An example in which the determination according to the color information is preferentially adopted has been explained, however, another method such that only when both the determination results agree with each other, the results are adopted may be used, as the method of combining the determination according to the color information and the determination according to the luminance information.

In the third embodiment, the lane determining unit 36 combines the determination of the driving lane based on the color information and that based on the luminance information, thereby enabling more accurate determination of the driving lane.

In the above embodiments, example in which the driving lane is determined by using the luminance information and the color information of the image has been explained. However, the driving lane may be determined by using the differential information instead of the luminance information and the color information. In a fourth embodiment, a driving lane determining apparatus that determines the driving lane by using the differential information of the image will be explained.

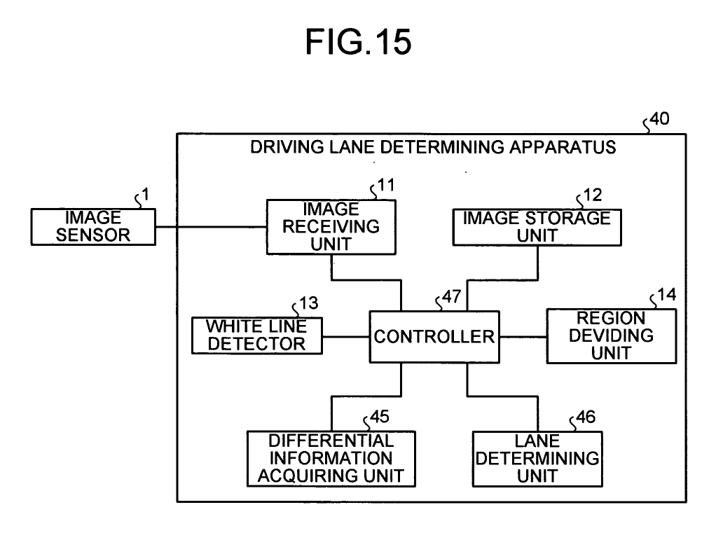

FIG. 15 is a functional block diagram of a driving lane determining apparatus 40 according to the fourth embodiment. For convenience, the functional units performing like roles as those of the respective units shown in FIG. 1 are designated by like reference signs, and the detailed explanation thereof is omitted.

The driving lane determining apparatus 40 includes the image receiving unit 11, the image storage unit 12, the white line detector 13, the region dividing unit 14, a differential information acquiring unit 45, a lane determining unit 46, and a controller 47 that controls the whole driving lane determining apparatus 40.

The differential information acquiring unit 45 applies a differential filter to each region divided into three by the region dividing unit 14 to calculate the respective mean values of the output values thereof. For the differential filter, a differential filter such as a Laplacian filter or a Sobel filter may be used. Calculation of the mean value is performed in the same manner as the calculation of the luminance information.

The lane determining unit 46 determines the driving lane by using the differential mean value calculated by the differential information acquiring unit 45. In other words, the lane determining unit 46 uses the differential mean value of two regions as an amount of characteristic, and compares the regions labeled as “label 1” and “label 2”, and the regions labeled as “label 1” and “label 3”, to determine the driving lane of the own vehicle.

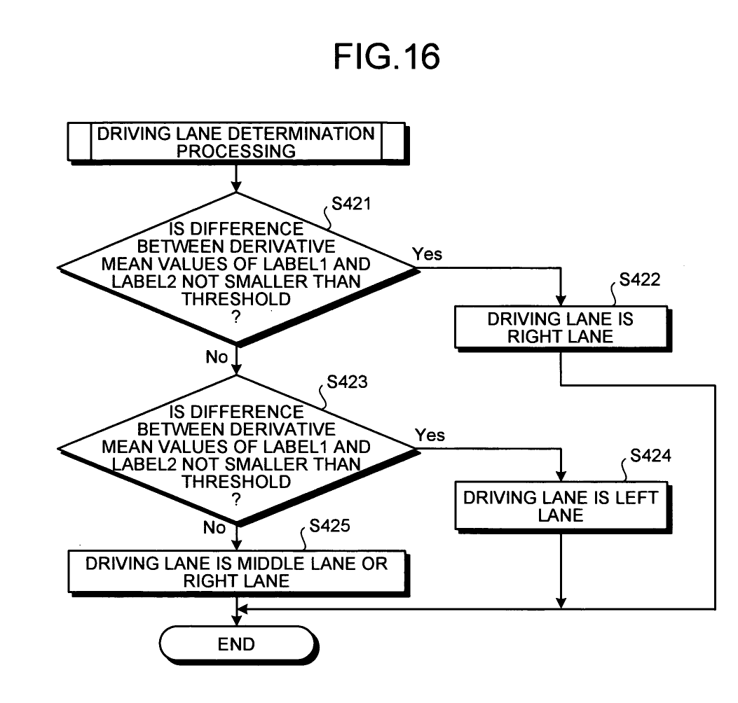

A driving lane determination processing performed by the lane determining unit 46 will be explained while referring to FIG. 16. The lane determining unit 46 determines whether a difference between a derivative mean value of the regions labeled as “label 1” and a derivative mean value of the regions labeled as “label 2” is not smaller than a threshold (step S421), and when the difference is not smaller than the threshold, since the situation on the road surface in the right side region is different from that of the driving lane, determines that the driving lane is the right lane (step S422).

On the other hand, when the difference between the derivative mean value of the regions labeled as “label 1” and the derivative mean value of the regions labeled as “label 2” is smaller than the threshold, the lane determining unit 46 determines whether a difference between a derivative mean value of the regions labeled as “label 1” and a derivative mean value of the regions labeled as “label 3” is not smaller than the threshold (step S423), and when the difference is not smaller than the threshold, since the situation on the road surface in the left side region is different from that of the driving lane, determines that the driving lane is the left lane (step S424).

On the other hand, when the difference between the derivative mean value of the regions labeled as “label 1” and the derivative mean value of the regions labeled as “label 3” is smaller than the threshold, since both the right and left sides are lanes, the driving lane determining apparatus 40 determines that the driving lane is the middle lane or the right lane (step S425).

In this manner, the lane determining unit 46 compares the derivative mean values between the driving lane region and the right and left regions and determines whether the comparison result is not smaller than the threshold to determine the driving lane. This enables determination of the driving lane.

In the fourth embodiment, the differential information acquiring unit 45 calculates the derivative mean value of the respective regions divided into three by the region dividing unit 14, and the lane determining unit 46 determines the driving lane by using the derivative mean value calculated by the differential information acquiring unit 45. As a result, the driving lane can be determined, regardless of the lane line being a solid line or a broken line.

In the first embodiment, an example in which the driving lane is determined by using the luminance information of the image has been explained, and in the fourth embodiment, an example in which the driving lane is determined by using the differential information of the image has been explained. However, the driving lane can be determined by using both the luminance information and the differential information. In a fifth embodiment a driving lane determining apparatus that determines the driving lane by using both the luminance information and the differential information of the image will be explained.

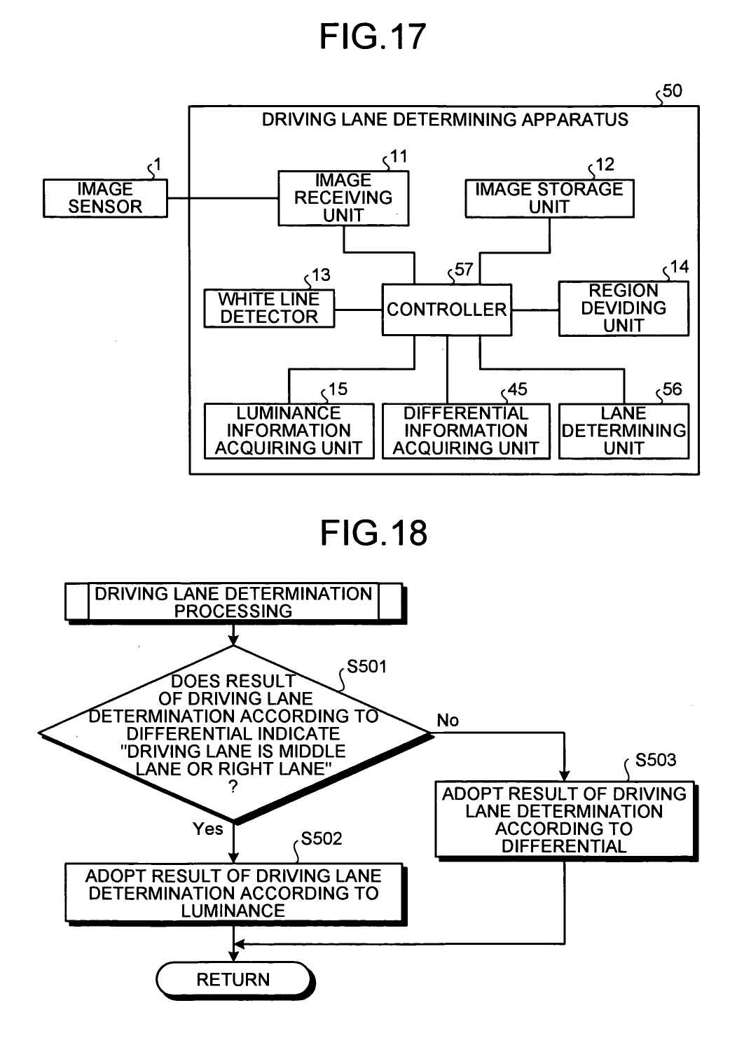

FIG. 17 is a functional block diagram of a driving lane determining apparatus 50 according to the fifth embodiment. For convenience, the functional units performing like roles as those of the respective units shown in FIG. 1 or FIG. 15 are designated by like reference signs, and the detailed explanation thereof is omitted.

The driving lane determining apparatus 50 includes the image receiving unit 11, the image storage unit 12, the white line detector 13, the region dividing unit 14, the luminance information acquiring unit 15, the differential information acquiring unit 45, a lane determining unit 56, and a controller 57 that controls the whole driving lane determining apparatus 50.

In other words, the driving lane determining apparatus 50 has both the luminance information acquiring unit 15 that calculates the luminance mean value of the respective regions divided into three by the region dividing unit 14, and the differential information acquiring unit 45 that calculates the derivative mean value of the respective regions.

The lane determining unit 56 uses both the luminance mean value calculated by the luminance information acquiring unit 15, and the derivative mean value calculated by the differential information acquiring unit 45, to determine the driving lane. Since the lane determining unit 56 uses both the luminance information and the derivative information for determination of the driving lane, accurate determination can be performed, even when adequate determination cannot be performed with the driving lane determination using the individual information.

For example, when the differential information hardly exists in the region on the shoulder of the road as on the road surface, however, the luminance is considerably higher than that of the road surface, the shoulder cannot be determined only by the differential information, however, can be determined by the luminance information.

A driving lane determination processing performed by the lane determining unit 56 will be explained with reference to FIG. 18. The lane determining unit 56 performs determination of the driving lane according to the differential, to determine whether the result indicates that “the driving lane is the middle lane or the right lane” (step S501).

When the determination result according to the differential indicates that “the driving lane is the middle lane or the right lane”, the lane determining unit 56 performs determination of the driving lane according to the luminance, and adopts the result as the driving lane determination result (step S502). When the determination result according to the differential does not indicate that “the driving lane is the middle lane or the right lane”, the lane determining unit 56 adopts the determination result according to the differential as the driving lane determination result (step S503).

Thus, the lane determining unit 56 preferentially adopts the determination according to the differential information, and when the determination result according to the differential indicates that “the driving lane is the middle lane or the right lane”, that is, when the shoulder of the road cannot be found by the differential information, the lane determining unit 56 adopts the determination result according to the luminance information. As a result, when the determination according to the differential information is not clear, the determination according to the luminance information can be used to determine the lane.

An example in which the determination according to the differential information is preferentially adopted has been explained, however, another method such that only when both the determination results agree with each other, the results are adopted may be used, as the method of combining the determination according to the differential information and the determination according to the luminance information.

In the fifth embodiment, the lane determining unit 56 combines the determination of the driving lane based on the differential information and that based on the luminance information, thereby enabling more accurate determination of the driving lane.

In the fifth embodiment, an example in which the luminance information and the differential information of the image are combined to determine the driving lane has been explained. However, the driving lane may be determined using both the color information and the differential information. In a sixth embodiment a driving lane determining apparatus that determines the driving lane by combining the color information and the differential information of the image will be explained.

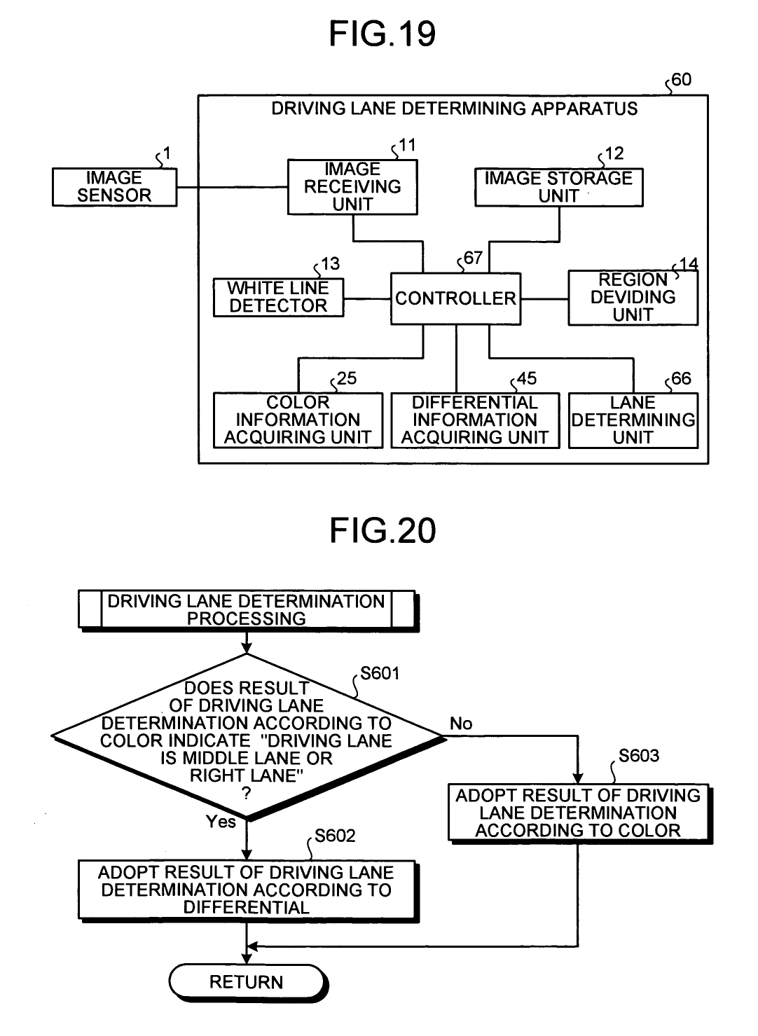

FIG. 19 is a functional block diagram of a driving lane determining apparatus 60 according to the sixth embodiment. For convenience, the functional units performing like roles as those of the respective units shown in FIG. 1 or FIG. 15 are designated by like reference signs, and the detailed explanation thereof is omitted.

The driving lane determining apparatus 60 includes the image receiving unit 11, the image storage unit 12, the white line detector 13, the region dividing unit 14, the color information acquiring unit 25, the differential information acquiring unit 45, a lane determining unit 66, and a controller 67 that controls the whole driving lane determining apparatus 60.

In other words, the driving lane determining apparatus 60 has both the color information acquiring unit 25 that calculates the mean value of color difference in the respective regions divided into three by the region dividing unit 14, and the differential information acquiring unit 45 that calculates the derivative mean value of the respective regions.

The lane determining unit 66 uses both the mean value of color difference calculated by the color information acquiring unit 25, and the derivative mean value calculated by the differential information acquiring unit 45, to determine the driving lane. Since the lane determining unit 66 uses both the color information and the derivative information for determination of the driving lane, accurate determination can be performed, even when adequate determination cannot be performed with the driving lane determination using the individual information.

For example, when the differential information hardly exists in the region on the shoulder of the road as on the road surface, however, there is a difference in the color information, or vice versa, the shoulder cannot be determined only by one of the information, however, can be determined by using both of the information.

A driving lane determination processing performed by the lane determining unit 66 will be explained with reference to FIG. 20. The lane determining unit 66 performs determination of the driving lane by the color, to determine whether the result indicates that “the driving lane is the middle lane or the right lane” (step S601).

When the determination result according to the color indicates that “the driving lane is the middle lane or the right lane”, the lane determining unit 66 performs the determination of the driving lane by the differential, and adopts the result as the driving lane determination result (step S602). When the determination result according to the color does not indicate that “the driving lane is the middle lane or the right lane”, the lane determining unit 66 adopts the determination result according to the color as the driving lane determination result (step S603).

Thus, the lane determining unit 66 preferentially adopts the determination according to the color information, and when the determination result according to the color indicates that “the driving lane is the middle lane or the right lane”, that is, when the shoulder of the road cannot be found according to the color information, the lane determining unit 66 adopts the determination result according to the differential information. As a result, when the determination according to the color information is not clear, the determination according to the differential information can be used to determine the lane.

An example in which the determination according to the color information is preferentially adopted has been explained, however, another method such that only when both the determination results agree with each other, the results are adopted may be used, as the method of combining the determination based on the color information and that based on the differential information.

In the sixth embodiment, the lane determining unit 66 combines determination of the driving lane according to the color information and determination thereof according to the differential information, thereby enabling more accurate determination of the driving lane.

In the fifth and the sixth embodiments, an example in which the differential information of the image is combined with the luminance information or the color information to determine the driving lane has been explained. However, all of the luminance information, the color information, and the differential information may be combined to determine the driving lane. In the seventh embodiment, therefore, a driving lane determining apparatus that determines the driving lane by combining the luminance information, the color information, and the differential information of the image will be explained.

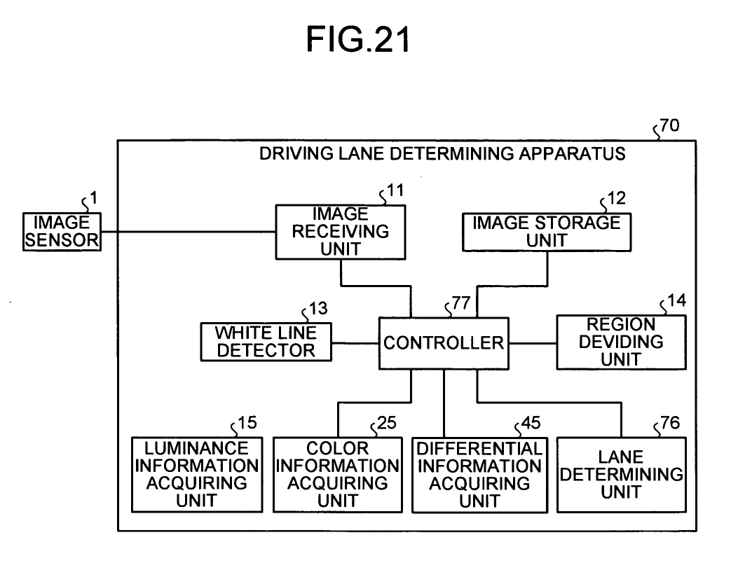

FIG. 21 is a functional block diagram of a driving lane determining apparatus 70 according to the seventh embodiment. For convenience, the functional units performing like roles as those of the respective units shown in FIG. 17 or FIG. 19 are designated by like reference signs, and the detailed explanation thereof is omitted.

The driving lane determining apparatus 70 includes the image receiving unit 11, the image storage unit 12, the white line detector 13, the region dividing unit 14, the luminance information acquiring unit 15, the color information acquiring unit 25, the differential information acquiring unit 45, a lane determining unit 76, and a controller 77 that controls the whole driving lane determining apparatus 70.

In other words, the driving lane determining apparatus 70 includes the luminance information acquiring unit 15 that calculates the luminance mean value in the respective regions divided into three by the region dividing unit 14, the color information acquiring unit 25 that calculates the mean value of color difference in the respective regions, and the differential information acquiring unit 45 that calculates the derivative mean value of the respective regions.

The lane determining unit 76 uses the luminance mean value calculated by the luminance information acquiring unit 15, the mean value of color difference calculated by the color information acquiring unit 25, and the derivative mean value calculated by the differential information acquiring unit 45, to determine the driving lane. Since the lane determining unit 76 uses the information of luminance, color, and differential for the determination of the driving lane, accurate determination can be performed, even when adequate determination cannot be performed with the driving lane determination using the individual information.

For example, when the region on the shoulder of the road is monotonous and hardly has the differential information as on the road surface, however, the luminance is considerably higher than that of the road surface, the shoulder cannot be determined only by the information of color and differential, however, can be determined by the luminance information.

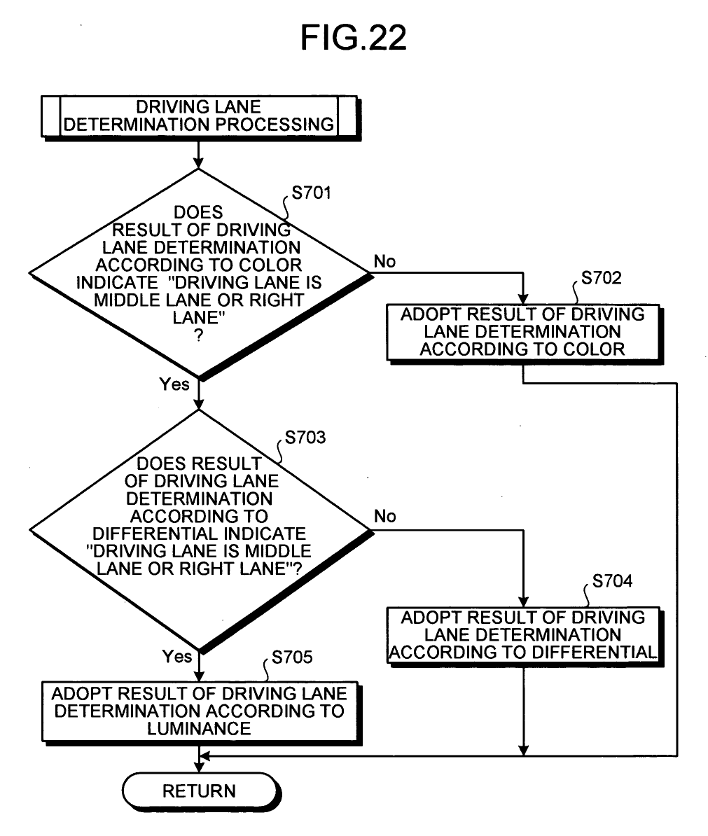

A driving lane determination processing performed by the lane determining unit 76 will be explained with reference to FIG. 22. The lane determining unit 76 performs determination of the driving lane by the color, to determine whether the result indicates that “the driving lane is the middle lane or the right lane” (step S701).

When the determination result according to the color does not indicate that “the driving lane is the middle lane or the right lane”, the lane determining unit 76 adopts the determination result according to the color as the driving lane determination result (step S702). When the determination result according to the color indicates that “the driving lane is the middle lane or the right lane”, the lane determining unit 76 performs the determination according to the differential, to determine whether the result indicates that “the driving lane is the middle lane or the right lane” (step S703).

When the determination result according to the differential does not indicate that “the driving lane is the middle lane or the right lane”, the lane determining unit 76 adopts the determination result according to the differential as the driving lane determination result (step S704). When the determination result according to the differential indicates that “the driving lane is the middle lane or the right lane”, the lane determining unit 76 performs the determination according to the luminance, and adopts the determination result according to the luminance as the driving lane determination result (step S705).

Thus, the lane determining unit 76 preferentially adopts the determination according to the color information, and when the determination result according to the color indicates that “the driving lane is the middle lane or the right lane”, that is, when the shoulder of the road cannot be found by the color information, the lane determining unit 76 adopts the determination result according to the differential information. When the shoulder of the road still cannot be found even by the differential information, the lane determining unit 76 adopts the determination result according to the luminance information. As a result, when the determination based on the color information is not clear, those based on the differential information and the luminance information can be used to determine the lane.

An example in which the determination according to the color information is preferentially adopted has been explained, however, another method such that only when all the determination results agree with each other, the results are adopted may be used, as the method of combining the determination according to the color information, the determination according to the differential information, and the determination according to the luminance information.

In the seventh embodiment, the lane determining unit 76 combines the determinations of the driving lane based on the color information, the differential information, and the luminance information, thereby enabling more accurate determination of the driving lane.

In the seventh embodiment, an example in which the driving lane is determined by using the luminance information and the like of the image has been explained. However, the driving lane may be determined by using frequency information instead of the luminance information and the like. In the eighth embodiment, a driving lane determining apparatus that determines the driving lane by using the frequency information of the image will be explained.

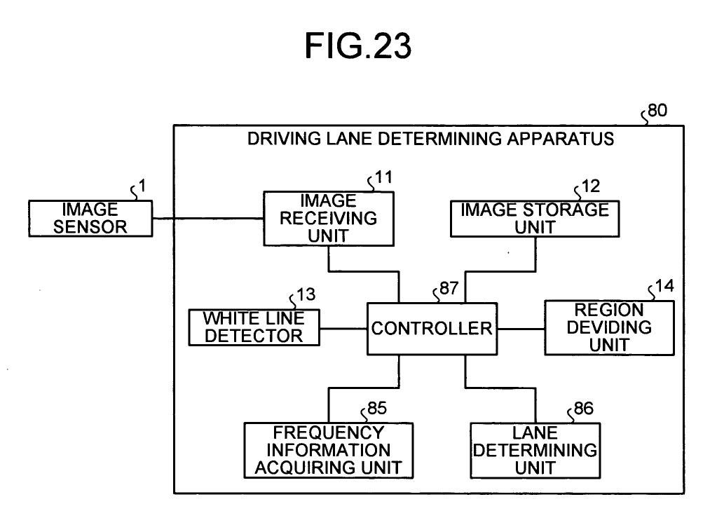

FIG. 23 is a functional block diagram of a driving lane determining apparatus 80 according to the eighth embodiment. For convenience, the functional units performing like roles as those of the respective units shown in FIG. 1 are designated by like reference signs, and the detailed explanation thereof is omitted.

The driving lane determining apparatus 80 includes the image receiving unit 11, the image storage unit 12, the white line detector 13, the region dividing unit 14, a frequency information acquiring unit 85, a lane determining unit 86, and a controller 87 that controls the whole driving lane determining apparatus 80.

The frequency information acquiring unit 85 transforms the image data of the respective regions divided into three by the region dividing unit 14 to frequency components by Fourier transform. For the Fourier transform, discrete Fourier transform (DFT) is used, and the two-dimensional discrete Fourier transform can be represented by the equation (2), when it is assumed that the input image is f[m, n], and the image size is M×N.

$$F [ k , 1 ] = \frac{1}{M \cdot N} {\sum }_{n = 0}^{N - 1} {\sum }_{m = o}^{M - 1} f [ m , n ] {W}_{1}^{km} {W}_{2}^{ln} \qquad ( 2 )$$

where
W₁=e^{-j 2π/M}, W₂=e^{-j 2π/N}
k=0,1,2, . . . , M−1,
I=0,1,2, . . . , N−1

The lane determining unit 86 determines the driving lane by using a frequency correlation value calculated by the frequency information acquiring unit 85. In other words, the lane determining unit 86 uses the frequency correlation value between two regions as an amount of characteristic, to compare the region of “label 1” with the region of “label 2”, and the region of “label 1” with the region of “label 3”, thereby determining the driving lane of the own vehicle.

The correlation value can be calculated using, for example, the equation (3), when it is assumed that the frequency information of “label a” is Fa[k, l], the frequency information of “label b” is Fb[k, l], and the image sizes thereof are both M×N.

$${\sum }_{n = 0}^{N - 1} {\sum }_{m = 0}^{M - 1} {\vert {F}_{a} [ m , n ] - {F}_{b} [ m , n ] \vert}^{2} \qquad ( 3 )$$

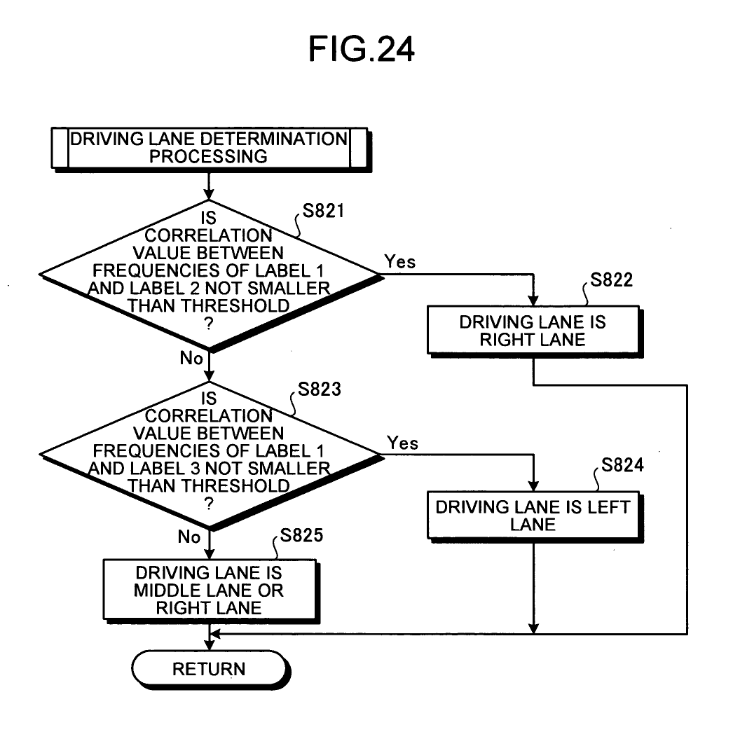

A driving lane determination processing performed by the lane determining unit 86 will be explained with reference to FIG. 24. The lane determining unit 86 determines whether the correlation value between the frequency in the region of “label 1” and the frequency in the region of “label 2” is not smaller than a threshold (step S821). When the correlation value is not smaller than the threshold, since the situation on the road surface in the right side region is different from that of the lane, the lane determining unit 86 determines that the driving lane is the right lane (step S822).

On the other hand, when the correlation value between the frequency in the region of “label 1” and the frequency in the region of “label 2” is smaller than the threshold, the lane determining unit 86 determines whether the correlation value between the frequency in the region of “label 1” and the frequency in the region of “label 3” is not smaller than the threshold (step S823). When the correlation value is not smaller than the threshold, since the situation on the road surface in the left side region is different from that of the lane, the lane determining unit 86 determines that the driving lane is the left lane (step S824).

On the other hand, when the correlation value between the frequency in the region of “label 1” and the frequency in the region of “label 3” is smaller than the threshold, since the right and left regions are both lanes, the lane determining unit 86 determines that the driving lane is the middle lane or the right lane (step S825).

Thus, the lane determining unit 86 calculates the correlation value of the frequency between the driving lane region and the right and the left regions, and determines whether the calculated correlation value is not smaller than the threshold, thereby enabling the determination of the driving lane.

In the eighth embodiment, the frequency information acquiring unit 85 transforms the image data in each region divided into three by the region dividing unit 14 to frequency components, and the lane determining unit 86 determines the driving lane by using the frequency transformed from the image data by the frequency information acquiring unit 85. As a result, the driving lane can be determined regardless of the lane line being a solid line or a broken line.

In the first embodiment, an example in which the driving lane is determined by using the luminance information of the image has been explained, and in the eighth embodiment, an example in which the driving lane is determined by using the frequency information of the image has been explained. However, the driving lane may be determined by using the luminance information and the frequency information. In a ninth embodiment a driving lane determining apparatus that determines the driving lane by using the luminance information and the frequency information of the image will be explained.

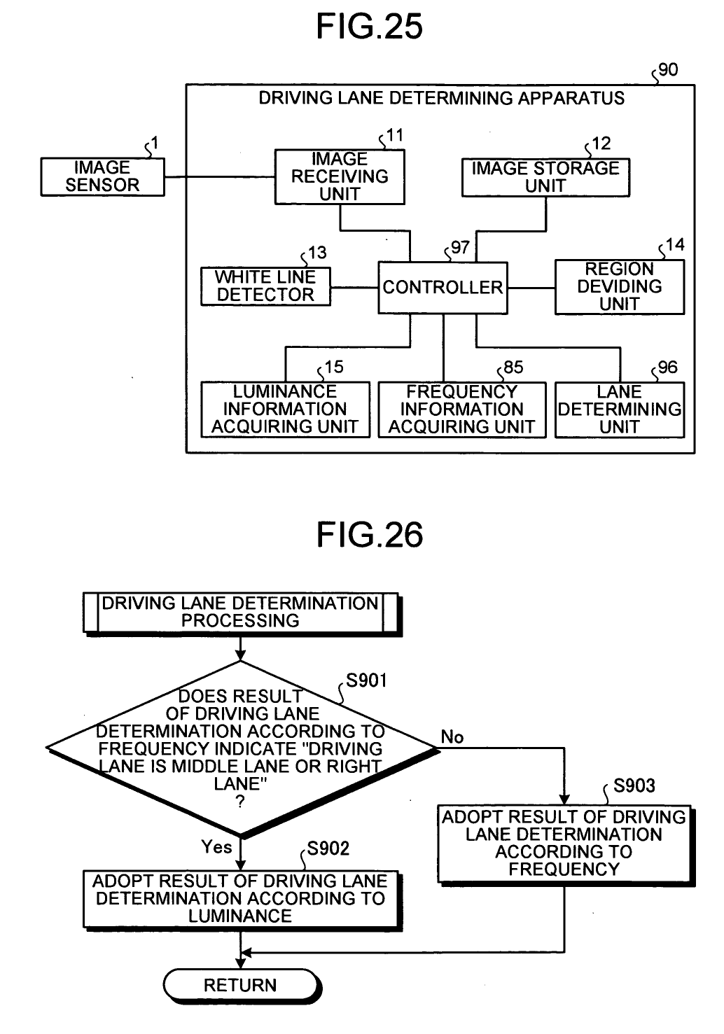

FIG. 25 is a functional block diagram of a driving lane determining apparatus 90 according to the ninth embodiment. For convenience, the functional units performing like roles as those of the respective units shown in FIG. 1 or FIG. 23 are designated by like reference signs, and the detailed explanation thereof is omitted.

The driving lane determining apparatus 90 includes the image receiving unit 11, the image storage unit 12, the white line detector 13, the region dividing unit 14, the luminance information acquiring unit 15, the frequency information acquiring unit 85, a lane determining unit 96, and a controller 97 that controls the whole driving lane determining apparatus 90.

In other words, the driving lane determining apparatus 90 includes the luminance information acquiring unit 15 that calculates the luminance mean value in the respective regions divided into three by the region dividing unit 14, and the frequency information acquiring unit 85 that calculates the frequency in each region.

The lane determining unit 96 uses the luminance mean value calculated by the luminance information acquiring unit 15, and the frequency calculated by the frequency information acquiring unit 85, to determine the driving lane. Since the lane determining unit 96 uses the information of luminance and frequency for determination of the driving lane, accurate determination can be performed, even when adequate determination cannot be performed with the driving lane determination using the individual information.

For example, when the region on the shoulder of the road hardly has the frequency information as on the road surface, however, the luminance is considerably higher than that of the road surface, the shoulder cannot be determined only based on the frequency information, however, can be determined based on the luminance information.

A driving lane determination processing performed by the lane determining unit 96 will be explained with reference to FIG. 26. The lane determining unit 96 performs determination of the driving lane by the frequency, to determine whether the result indicates that “the driving lane is the middle lane or the right lane” (step S901).

When the determination result according to the frequency indicates that “the driving lane is the middle lane or the right lane”, the lane determining unit 96 performs determination according to the luminance, and adopts the determination result according to the luminance as the driving lane determination result (step S902). When the determination result according to the frequency does not indicate that “the driving lane is the middle lane or the right lane”, the lane determining unit 96 adopts the determination result according to the frequency as the driving lane determination result (step S903).

Thus, the lane determining unit 96 preferentially adopts the determination according to the frequency information, and when the determination result according to the frequency information indicates that “the driving lane is the middle lane or the right lane”, that is, when the shoulder of the road cannot be found by the frequency information, the lane determining unit 96 adopts the determination result according to the luminance information. As a result, when the determination according to the frequency information is not clear, the determination according to the luminance information can be used to determine the lane.

An example in which the determination according to the frequency information is preferentially adopted has been explained, however, another method such that only when both the determination results agree with each other, the results are adopted may be used, as the method of combining the determinations based on the frequency information and the luminance information.

In the ninth embodiment, the lane determining unit 96 can determine the driving lane more accurately by combining the determinations of the driving lane based on the frequency information and the luminance information.

In the ninth embodiment, an example in which the driving lane is determined by combining the luminance information and the frequency information of the image has been explained, however, the driving lane may be determined by combining the color information and the frequency information of the image. In a tenth embodiment, a driving lane determining apparatus that determines the driving lane by combining the color information and the frequency information of the image will be explained.

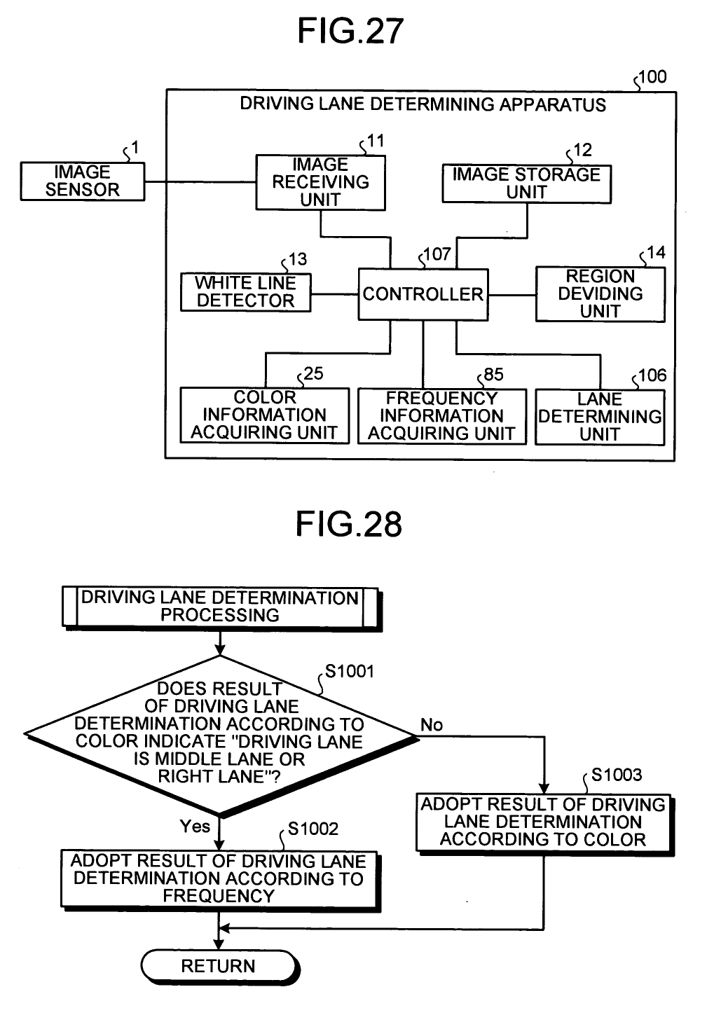

FIG. 27 is a functional block diagram of a driving lane determining apparatus 100 according to the tenth embodiment. For convenience, the functional units performing like roles as those of the respective units shown in FIG. 11 or FIG. 23 are designated by like reference signs, and the detailed explanation thereof is omitted.

The driving lane determining apparatus 100 includes the image receiving unit 11, the image storage unit 12, the white line detector 13, the region dividing unit 14, the color information acquiring unit 25, the frequency information acquiring unit 85, a lane determining unit 106, and a controller 107 that controls the whole driving lane determining apparatus 100.

In other words, the driving lane determining apparatus 100 includes the color information acquiring unit 25 that calculates the mean value of color difference in the respective regions divided into three by the region dividing unit 14, and the frequency information acquiring unit 85 that calculates the frequency in each region.

The lane determining unit 106 uses the mean value of the color difference calculated by the color information acquiring unit 25, and the frequency calculated by the frequency information acquiring unit 85, to determine the driving lane. Since the lane determining unit 106 uses the information of color and frequency for the determination of the driving lane, accurate determination can be performed, even when adequate determination cannot be performed with the driving lane determination using the individual information.

For example, when the region on the shoulder of the road hardly has the color information as on the road surface, however, the frequency information exists, the shoulder cannot be determined only by the color information, however, can be determined by the frequency information.

A driving lane determination processing performed by the lane determining unit 106 will be explained with reference to FIG. 28. The lane determining unit 106 performs the determination of the driving lane according to the color, to determine whether the result indicates that “the driving lane is the middle lane or the right lane” (step S1001).

When the determination result according to the color indicates that “the driving lane is the middle lane or the right lane”, the lane determining unit 106 performs determination according to the frequency, and adopts the determination result according to the frequency as the driving lane determination result (step S1002). When the determination result according to the color does not indicate that “the driving lane is the middle lane or the right lane”, the lane determining unit 106 adopts the determination result according to the color as the driving lane determination result (step S1003).

Thus, the lane determining unit 106 preferentially adopts the determination according to the color information, and when the determination result according to the color information indicates that “the driving lane is the middle lane or the right lane”, that is, when the shoulder of the road cannot be found by the color information, the lane determining unit 106 adopts the determination result according to the frequency information. As a result, when the determination according to the color information is not clear, the determination according to the frequency information can support the determination.

An example in which the determination according to the color information is preferentially adopted has been explained, however, another method such that only when both the determination results agree with each other, the results are adopted may be used, as the method of combining the determinations based on the color information and the frequency information.

In the tenth embodiment, the lane determining unit 106 can determine the driving lane more accurately by combining the determination of the driving lane according to the color information and the determination according to the frequency information.

In the seventh embodiment, an example in which the driving lane is determined by combining the luminance information, the color information, and the differential information has been explained, however, the driving lane may be determined by combining the luminance information, the color information, and the frequency information. In an eleventh embodiment, a driving lane determining apparatus that determines the driving lane by combining the luminance information, the color information, and the frequency information of the image will be explained.

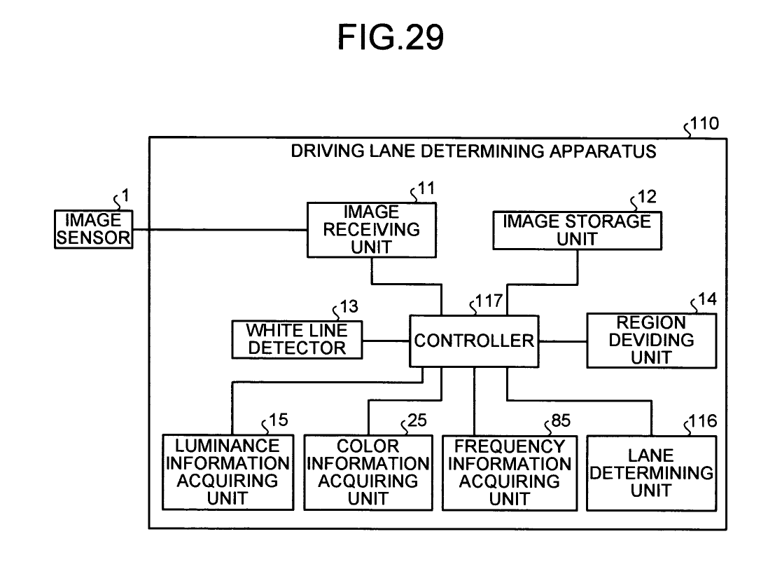

FIG. 29 is a functional block diagram of a driving lane determining apparatus 110 according to the eleventh embodiment. For convenience, the functional units performing like roles as those of the respective units shown in FIGS. 1, 11, or 23 are designated by like reference signs, and the detailed explanation thereof is omitted.

As shown in FIG. 29, the driving lane determining apparatus 110 includes the image receiving unit 11, the image storage unit 12, the white line detector 13, the region dividing unit 14, the luminance information acquiring unit 15, the color information acquiring unit 25, the frequency information acquiring unit 85, a lane determining unit 116, and a controller 117 that controls the whole driving lane determining apparatus 110.

In other words, the driving lane determining apparatus 110 includes the luminance information acquiring unit 15 that calculates the luminance mean value in the respective regions divided into three by the region dividing unit 14, the color information acquiring unit 25 that calculates the mean value of the color difference in the respective regions, and the frequency information acquiring unit 85 that calculates the frequency in each region.

The lane determining unit 116 uses the luminance mean value calculated by the luminance information acquiring unit 15, the mean value of the color difference calculated by the color information acquiring unit 25, and the frequency calculated by the frequency information acquiring unit 85, to determine the driving lane. Since the lane determining unit 116 uses the luminance information, the color information, and the frequency information for the determination of the driving lane, accurate determination can be performed, even when adequate determination cannot be performed with the driving lane determination using the individual information.

For example, when the region on the shoulder of the road is monotonous and hardly has the frequency information as on the road surface, however, the luminance is considerably high, the shoulder cannot be determined only by to the information of the color and the frequency, however, can be determined by the luminance information.

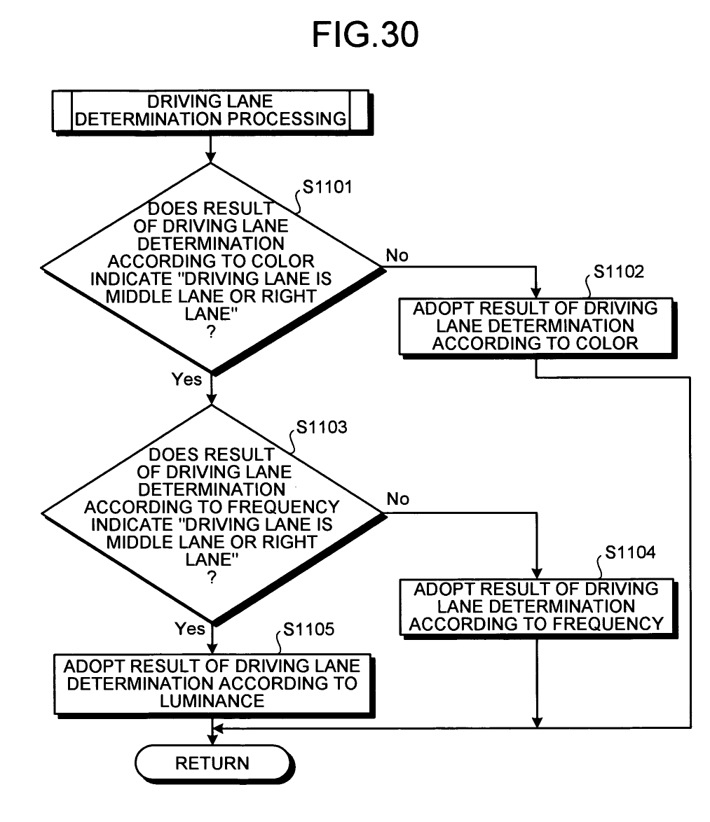

A driving lane determination processing performed by the lane determining unit 116 will be explained with reference to FIG. 30. The lane determining unit 116 performs the determination of the driving lane by the color, to determine whether the result indicates that “the driving lane is the middle lane or the right lane” (step S1101).

When the determination result according to the color does not indicate that “the driving lane is the middle lane or the right lane”, the lane determining unit 116 adopts the determination result according to the color as the driving lane determination result (step S1102). When the determination result according to the color indicates that “the driving lane is the middle lane or the right lane”, the lane determining unit 116 performs the determination according to the frequency, to determine whether the determination result indicates that “the driving lane is the middle lane or the right lane” (step S1103).

When the determination result according to the frequency does not indicate that “the driving lane is the middle lane or the right lane”, the lane determining unit 116 adopts the determination result according to the frequency as the driving lane determination result (step S1104). When the determination result according to the frequency indicates that “the driving lane is the middle lane or the right lane”, the lane determining unit 116 performs the determination based on the luminance, and adopts the determination result according to the luminance as the driving lane determination result (step S1105).

Thus, the lane determining unit 116 preferentially adopts the determination according to the color information, and when the determination result according to the color information indicates that “the driving lane is the middle lane or the right lane”, that is, when the shoulder of the road cannot be found by the color information, the lane determining unit 116 adopts the determination result according to the frequency information. When the shoulder of the road cannot be found by the frequency information, the lane determining unit 116 adopts the determination result according to the luminance. As a result, when the determination according to the color information is not clear, the determination according to the frequency information and the luminance can support the determination.

An example in which the determination according to the color information is preferentially adopted has been explained, however, another method such that only when all the determination results agree with each other, the results are adopted may be used, as the method of combining the determination according to the color information, the determination according to the frequency information, and he determination according to the luminance information.

In the eleventh embodiment, the lane determining unit 116 can determine the driving lane more accurately by combining the determination of the driving lane according to the color information, the frequency information, and the luminance information.

In the above embodiments, an example in which the driving lane is determined by detecting the shoulder of the road by using the luminance information and the like included in the image has been explained. However, the driving lane can be determined by detecting an oncoming vehicle instead of detecting the shoulder. In a twelfth embodiment, a driving lane determining apparatus that determines the driving lane by detecting the oncoming vehicle will be explained.

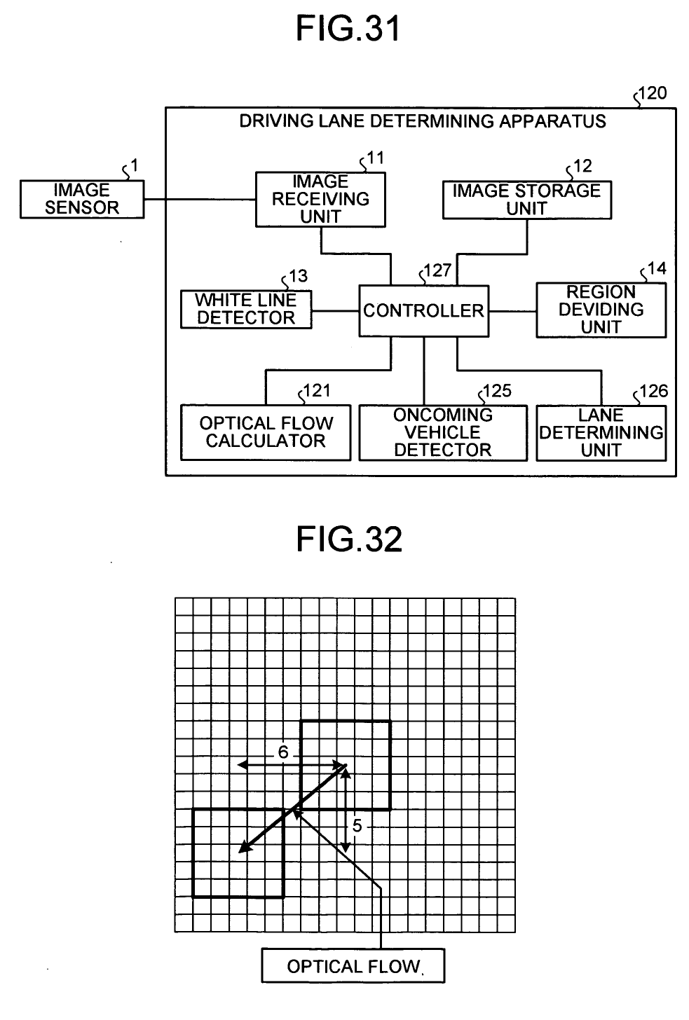

FIG. 31 is a functional block diagram of a driving lane determining apparatus 120 according to the twelfth embodiment. For convenience, the functional units performing like roles as those of the respective units shown in FIG. 1 are designated by like reference signs, and the detailed explanation thereof is omitted.

The driving lane determining apparatus 120 includes the image receiving unit 11, the image storage unit 12, the white line detector 13, the region dividing unit 14, an optical flow calculator 121, an oncoming vehicle detector 125, a lane determining unit 126, and a controller 127 that controls the whole driving lane determining apparatus 120.

The optical flow calculator 121 calculates an optical flow in the respective regions divided into three by the region dividing unit 14. The optical flow is a method of expressing a certain point in an image, or an apparent movement on the image in a region by a direction and size of an arrow, in a dynamic scene analysis, and various methods such as a correlation method and a concentration gradient method are known as the optical flow detection method. Although the optical flow is detected by using the correlation method in this embodiment, the optical flow may be calculated by any other method.

The optical flow is calculated using images of continuous two frames fₙ(x, y) and fₙ₊₁(x, y). A rectangular region (block) of a certain size in fₙ(x, y), and a block that has similar luminance distribution in fₙ₊₁(x, y) are searched.

As an amount that indicates the similarity in the luminance distribution in the two blocks, a luminance correlation value is used. There are several methods for calculating the luminance correlation value in the block, however, the following equation is used:
ΣΣ|fₙ₊₁(x−mₓ, y−m_{y})−fₙ(x, y)|².

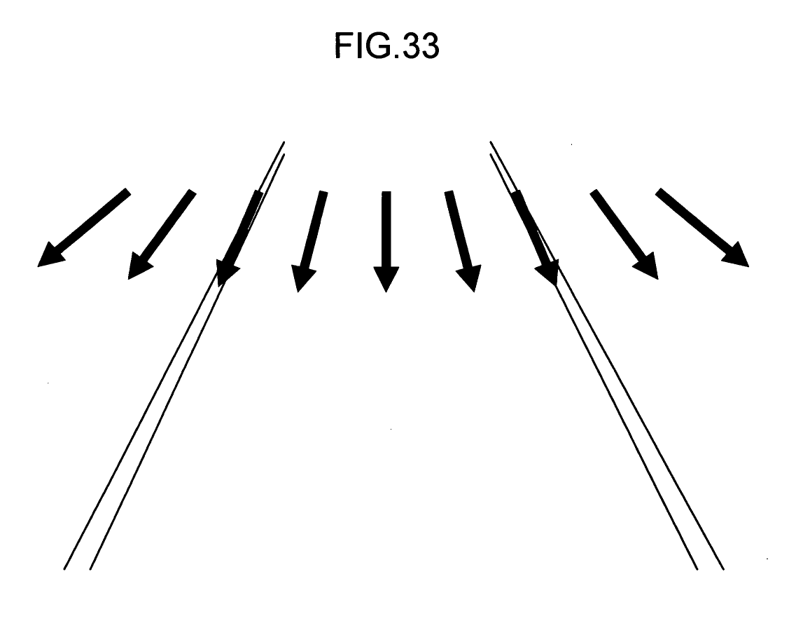

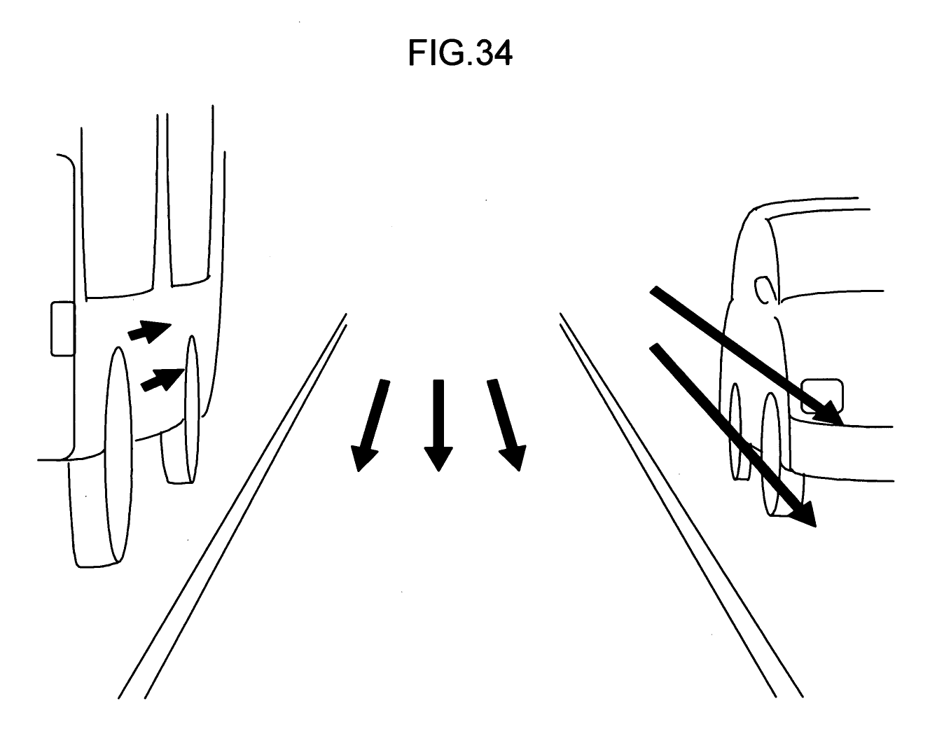

The movement (mₓ, m_{y}) in which the correlation value becomes minimum is the optical flow. FIG. 32 is a diagram for explaining the optical flow. When the size of the block is assumed to be 5×5, the correlation value becomes the smallest when moving to the left by 6 and downward by 5 so that the optical flow is (−6, 5).

FIG. 33 is a schematic of an optical flow when there is no oncoming vehicle and/or an adjacent parallel vehicle. FIG. 34 is a schematic of an optical flow when there is an oncoming vehicle and/or an adjacent parallel vehicle. In the case of FIG. 33, the optical flow occurs in the whole region of the image by the movement of the own vehicle, and the optical flow can be calculated by the speed of the own vehicle and parameters of the camera.

On the other hand, when an oncoming vehicle is traveling as shown in FIG. 34, since the relative speed of the own vehicle and the oncoming vehicle is fast, a large optical flow occurs. On the other hand, in case of the adjacent parallel vehicle, since the relative speed of the own vehicle and the adjacent parallel vehicle is slow or even negative, the optical flow is small or even in an opposite direction. By using these facts, the oncoming vehicle and the adjacent parallel vehicle can be detected.

The oncoming vehicle detector 125 detects an oncoming vehicle, by using the optical flow calculated by the optical flow calculator 121. Specifically, the oncoming vehicle detector 125 compares the optical flow in the region of “label 1” with the optical flow in the region of “label 2”, and when the optical flow in the region of “label 2” is larger than the optical flow in the region of “label 1”, and the difference thereof is larger than a predetermined threshold, the oncoming vehicle detector 125 determines that there is an oncoming vehicle in the region of “label 2”.

The lane determining unit 126 determines the driving lane based on the detection result of the oncoming vehicle by the oncoming vehicle detector 125. In other words, when the oncoming vehicle detector 125 determines that there is an oncoming vehicle in the region of “label 2”, the lane determining unit 126 determines that the driving lane is the right lane.

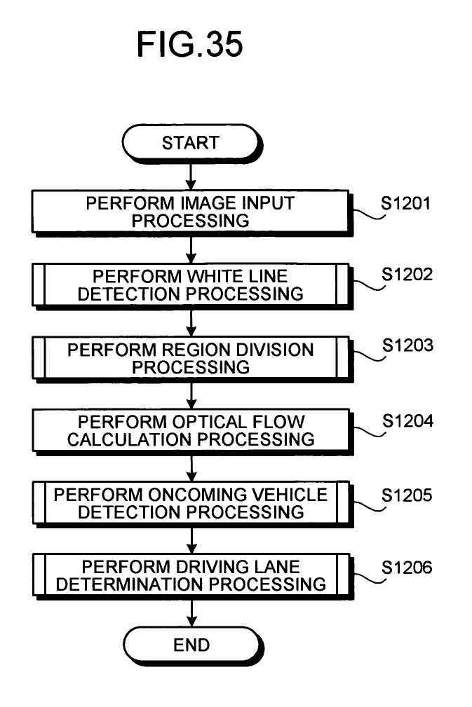

A process procedure performed by the driving lane determining apparatus 120 according to the twelfth embodiment will be explained with reference to FIG. 35. The driving lane determining apparatus 120 first performs image input processing, in which the image receiving unit 11 receives the image information from the image sensor and stores the information in the image storage unit 12 (step S1201).

The white line detector 13 uses the image information stored in the image storage unit 12 to detect two white lines (step S1202, white line detection processing), and the region dividing unit 14 divides the predetermined image area into three regions by using the two white lines detected by the white line detector 13 (step S1203, region division processing).

The optical flow calculator 121 calculates the optical flows in the respective regions divided into three by the region dividing unit 14 (step S1204, optical flow calculation processing), and the oncoming vehicle detector 125 detects an oncoming vehicle in the right region by a comparison between the optical flows in the region of “label 1” and the region of “label 2” calculated by the optical flow calculator 121 (step S1205, oncoming vehicle detection processing). The lane determining unit 126 determines the driving lane by using the oncoming vehicle detection result by the oncoming vehicle detector 125 (step S1206, driving lane determination processing).

In this manner, when there is an oncoming vehicle in the right region, the lane determining unit 126 determines the driving lane by using the oncoming vehicle detection result in the right region. As a result, the driving lane determining apparatus 120 can specify the driving lane as the right lane, regardless of the lane line being a solid line or a broken line.

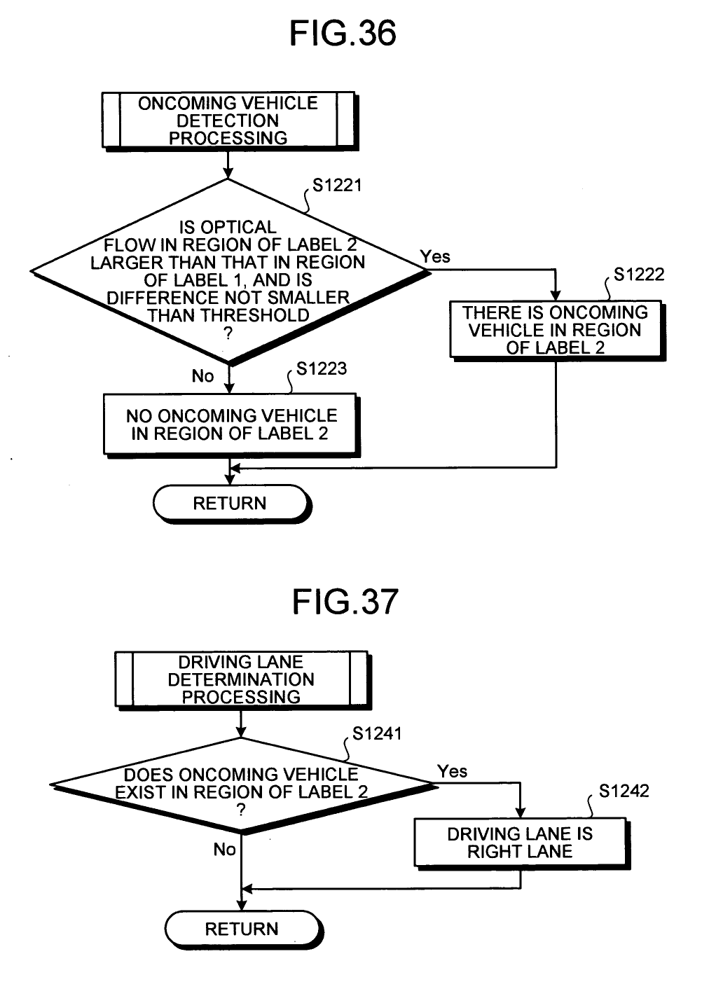

The oncoming vehicle detection processing (step S1205) will be explained with reference to FIG. 36. The oncoming vehicle detection processing is performed by the oncoming vehicle detector 125.

In the oncoming vehicle detection processing, it is determined whether the optical flow in the region of “label 2” is larger than that in the region of “label 1”, and the difference thereof is not smaller than a threshold (step S1221).

As a result, when the optical flow in the region of “label 2” is larger than that in the region of “label 1”, and the difference thereof is not smaller than the threshold, it is determined that there is an oncoming vehicle in the region of “label 2” (step S1222), and in other cases, it is determined that there is no oncoming vehicle in the region of “label 2” (step S1223).

Thus, with the oncoming vehicle detection processing, the oncoming vehicle in the right region can be detected by the comparison between the optical flows in the region of “label 1” and the region of “label 2”.

A driving lane determination processing (step S1206) will be explained with reference to FIG. 37. The driving lane determination processing is performed by the lane determining unit 126.

In the driving lane determination processing, it is determined whether an oncoming vehicle exists in the region of “label 2” (step S1241), and when there is an oncoming vehicle in the region of “label 2”, it is determined that the driving lane is the right lane (step S1242).

In this manner, in the driving lane determination processing, when there is an oncoming vehicle in the region of “label 2”, the driving lane can be specified as the right lane.

In the twelfth embodiment, the optical flow calculator 121 calculates the optical flows in the respective regions divided into three by the region dividing unit 14, the oncoming vehicle detector 125 uses the optical flows calculated by the optical flow calculator 121, to detect an oncoming vehicle in the right region, and when the oncoming vehicle detector 125 detects an oncoming vehicle in the right region, the lane determining unit 126 specifies the driving lane as the right lane. As a result, the driving lane can be specified as the right lane, regardless of the lane line being a solid line or a broken line.

In the twelfth embodiment, an example in which an oncoming vehicle is detected to determine the driving lane as the right lane has been explained. However, an adjacent parallel vehicle may be detected, instead of the oncoming vehicle, to determine the driving lane. In a thirteenth embodiment, a driving lane determining apparatus that determines the driving lane by detecting an adjacent parallel vehicle will be explained.

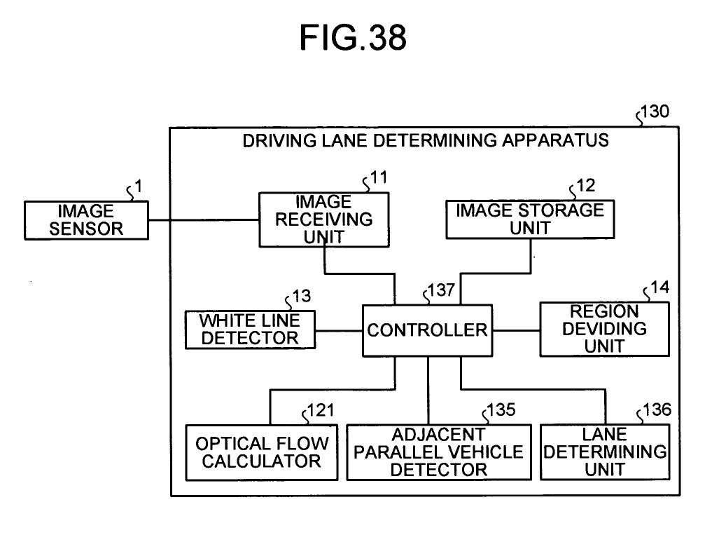

FIG. 38 is a functional block diagram of a driving lane determining apparatus 130 according to the thirteenth embodiment. For convenience, the functional units performing like roles as those of the respective units shown in FIG. 31 are designated by like reference signs, and the detailed explanation thereof is omitted.

The driving lane determining apparatus 130 includes the image receiving unit 11, the image storage unit 12, the white line detector 13, the region dividing unit 14, the optical flow calculator 121, an adjacent parallel vehicle detector 135, a lane determining unit 136, and a controller 137 that controls the whole driving lane determining apparatus 130.

The adjacent parallel vehicle detector 135 detects an adjacent parallel vehicle by using the optical flow calculated by the optical flow calculator 121. Specifically, the adjacent parallel vehicle detector 135 compares the optical flow in the region of “label 1” with the optical flow in the region of “label 2”. When the optical flow in the region of “label 2” is smaller than the optical flow in the region of “label 1”, and the difference thereof is not smaller than a predetermined threshold, the adjacent parallel vehicle detector 135 determines that there is an adjacent parallel vehicle in the region of “label 2”.

The adjacent parallel vehicle detector 135 also compares the optical flow in the region of “label 1” with the optical flow in the region of “label 3”. When the optical flow in the region of “label 3” is smaller than the optical flow in the region of “label 1”, and the difference thereof is not smaller than the predetermined threshold, the adjacent parallel vehicle detector 135 determines that there is an adjacent parallel vehicle in the region of “label 3”.

The lane determining unit 136 determines the driving lane based on the detection result of the adjacent parallel vehicle by the adjacent parallel vehicle detector 135. In other words, when there are the adjacent parallel vehicles both in the region of “label 2” and the region of “label 3”, the lane determining unit 136 determines that the driving lane is the middle lane.

When there is the adjacent parallel vehicle only in the region of “label 2”, the lane determining unit 136 determines that the driving lane is the left lane or the middle lane, and when there is the adjacent parallel vehicle only in the region of “label 3”, determines that the driving lane is the right lane or the middle lane.

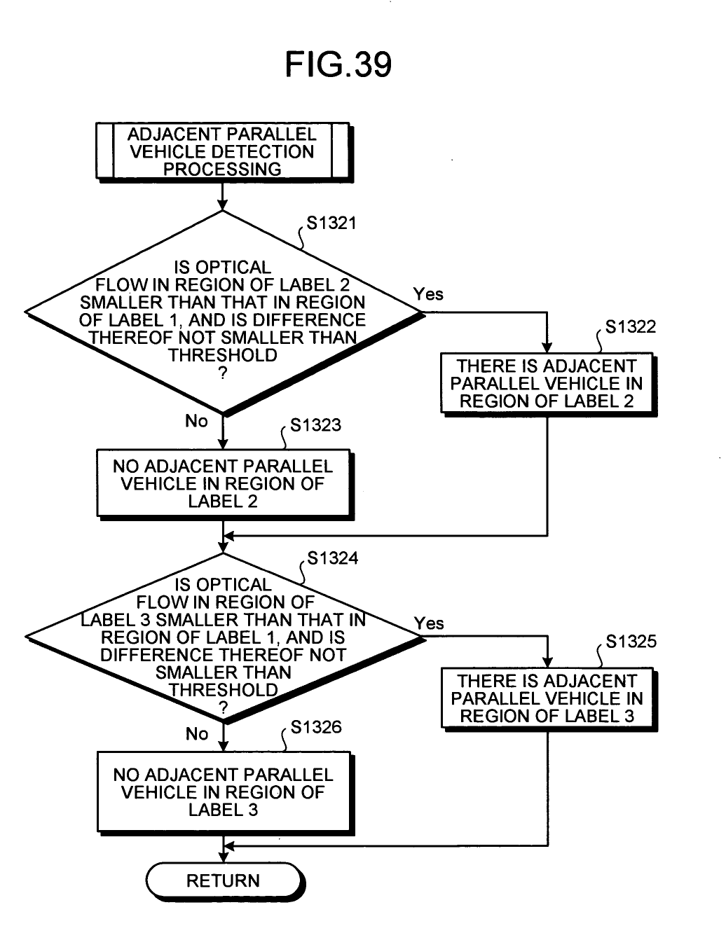

The adjacent parallel vehicle detection processing performed by the adjacent parallel vehicle detector 135 will be explained with reference to FIG. 39. In the adjacent parallel vehicle detection processing, it is determined whether the optical flow in the region of “label 2” is smaller than that in the region of “label 1”, and the difference thereof is not smaller than the threshold (step S1321).

As a result, when the optical flow in the region of “label 2” is smaller than that in the region of “label 1”, and the difference thereof is not smaller than the threshold, the adjacent parallel vehicle detector 135 determines that there is an adjacent parallel vehicle in the region of “label 2” (step S1322), and in other cases, determines that there is no adjacent parallel vehicle in the region of “label 2” (step S1323).

Moreover, it is determined whether the optical flow in the region of “label 3” is smaller than that in the region of “label 1”, and the difference thereof is not smaller than the threshold (step S1324).

As a result, when the optical flow in the region of “label 3” is smaller than that in the region of “label 1”, and the difference thereof is not smaller than the threshold, the adjacent parallel vehicle detector 135 determines that there is an adjacent parallel vehicle in the region of “label 3” (step S1325), and in other cases, determines that there is no adjacent parallel vehicle in the region of “label 3” (step S1326).

Thus, in the adjacent parallel vehicle detection processing, the adjacent parallel vehicle in the right region can be detected by the comparison between the optical flow in the region of “label 1” and the optical flow in the region of “label 2”, and the adjacent parallel vehicle in the left region can be detected by the comparison between the optical flow in the region of “label 1” and the optical flow in the region of “label 3”.

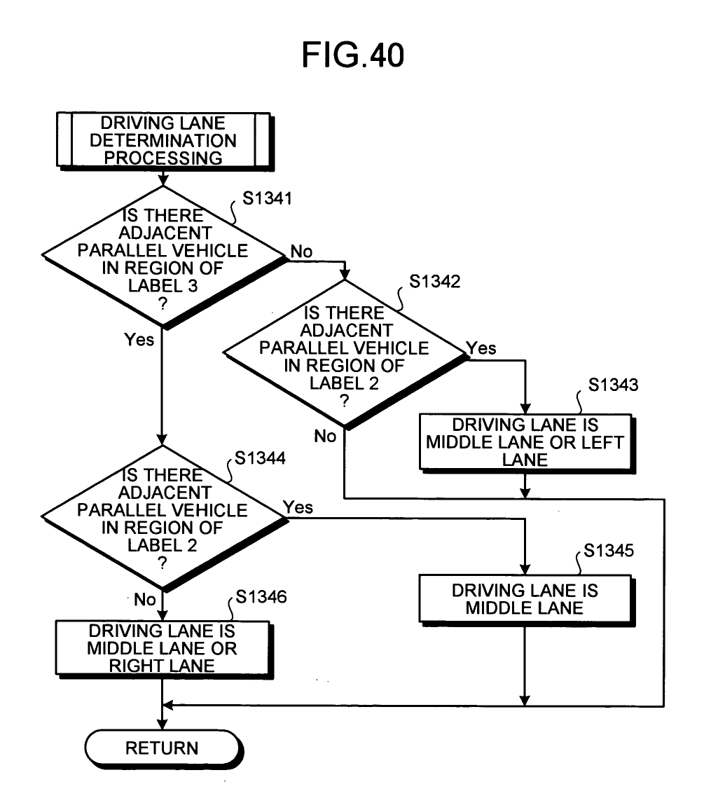

A driving lane determination processing performed by the lane determining unit 136 will be explained with reference to FIG. 40.

In the driving lane determination processing, it is determined whether there is an adjacent parallel vehicle in the region of “label 3” (step S1341), and when there is an adjacent parallel vehicle in the region of “label 3”, it is then determined whether there is an adjacent parallel vehicle in the region of “label 2” (step S1342). As a result, when there is an adjacent parallel vehicle in the region of “label 2”, the lane determining unit 136 determines that the driving lane is the middle lane or the left lane (step S1343).

On the other hand, when an adjacent parallel vehicle does not exist in the region of “label 3”, it is determined whether there is an adjacent parallel vehicle in the region of “label 2” (step S1344). When there is an adjacent parallel vehicle in the region of “label 2”, the lane determining unit 136 determines that the driving lane is the middle lane (step S1345), and when an adjacent parallel vehicle does not exist in the region of “label 2”, the lane determining unit 136 determines that the driving lane is the middle lane or the right lane (step S1346).

Thus, in the driving lane determination processing, the driving lane can be determined based on the existence of the adjacent parallel vehicle in the region of “label 2” or “label 3”.

In the thirteenth embodiment, the optical flow calculator 121 calculates the optical flow in the respective regions divided into three by the region dividing unit 14, the adjacent parallel vehicle detector 135 detects an adjacent parallel vehicle by using the optical flow calculated by the optical flow calculator 121, and the lane determining unit 136 determines the driving lane based on the adjacent parallel vehicle detected by the adjacent parallel vehicle detector 135. As a result, the driving lane can be determined, regardless of the lane line being a solid line or a broken line.

In the twelfth embodiment, an example in which the driving lane is determined by detecting the oncoming vehicle has been explained, and in the thirteenth embodiment, an example in which the driving lane is determined by detecting the adjacent parallel vehicle has been explained. However, the driving lane may be determined by detecting both the oncoming vehicle and the adjacent parallel vehicle. In a fourteenth embodiment a driving lane determining apparatus that determines the driving lane by detecting both the oncoming vehicle and the adjacent parallel vehicle will be explained.

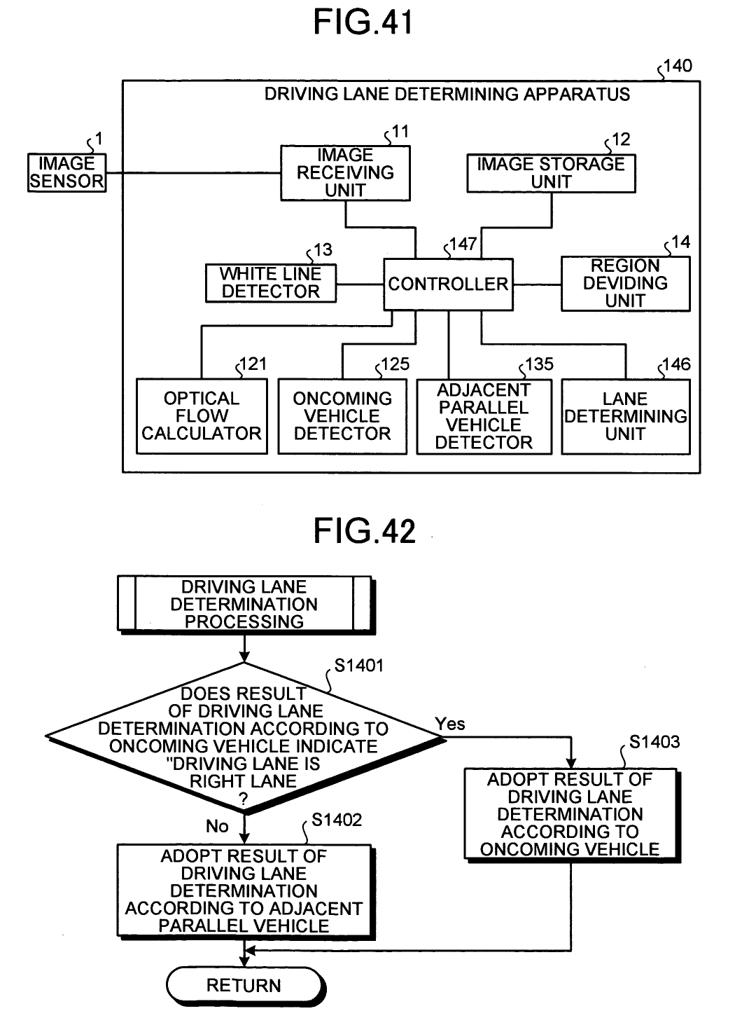

FIG. 41 is a functional block diagram of a driving lane determining apparatus 140 according to the fourteenth embodiment. For convenience, the functional units performing like roles as those of the respective units shown in FIG. 31 or 38 are designated by like reference signs, and the detailed explanation thereof is omitted.

The driving lane determining apparatus 140 includes the image receiving unit 11, the image storage unit 12, the white line detector 13, the region dividing unit 14, the optical flow calculator 121, the oncoming vehicle detector 125, the adjacent parallel vehicle detector 135, a lane determining unit 146, and a controller 147 that controls the whole driving lane determining apparatus 140.

That is, the driving lane determining apparatus 140 includes the oncoming vehicle detector 125, and the adjacent parallel vehicle detector 135.

The lane determining unit 146 determines the driving lane by using both the information of the oncoming vehicle detected by the oncoming vehicle detector 125, and the information of the adjacent parallel vehicle detected by the adjacent parallel vehicle detector 135. By using the information of the oncoming vehicle and the adjacent parallel vehicle for the determination of the driving lane, the lane determining unit 146 can perform accurate determination, even when adequate determination cannot be performed with the individual information.

A driving lane determination processing performed by the lane determining unit 146 will be explained with reference to FIG. 42. The lane determining unit 146 determines the driving lane according to the oncoming vehicle, and determines whether the result indicates that “the driving lane is the right lane” (step S1401).

When the determination result according to the oncoming vehicle does not indicate that “the driving lane is the right lane”, the lane determining unit 146 performs determination of the driving lane according to the adjacent parallel vehicle, and adopts the result thereof as the driving lane determination result (step S1402). When the determination result according to the oncoming vehicle indicates that “the driving lane is the right lane”, the lane determining unit 146 adopts the determination result according to the oncoming vehicle as the driving lane determination result (step S1403).

Thus, the lane determining unit 146 preferentially adopts the determination according to the oncoming vehicle, and when the oncoming vehicle does not exist, adopts the determination result according to the adjacent parallel vehicle. As a result, even if the oncoming vehicle does not exist, the driving lane determination can be performed.

An example in which the determination according to the oncoming vehicle is preferentially adopted has been explained, however, other methods may be used as the method for combining the determination according to the oncoming vehicle and the determination according to the adjacent parallel vehicle.

In the fourteenth embodiment, by combining the determination of the driving lane according to the oncoming vehicle and the determination thereof according to the adjacent parallel vehicle, the lane determining unit 146 can determine the driving lane more accurately.

The information of the luminance, the color, and the differential is used to determine the driving lane by determining the shoulder of the road. On the other hand, the information of the oncoming vehicle and the adjacent parallel vehicle is used to determine the driving lane by determining the situation of the surrounding traffic.

Therefore, by performing determination by combining these pieces of the information, the driving lane can be determined in more detail and more accurately. In a fifteenth embodiment, a driving lane determining apparatus that performs determination of the driving lane by combining the shoulder information and the information of the oncoming vehicle will be explained.

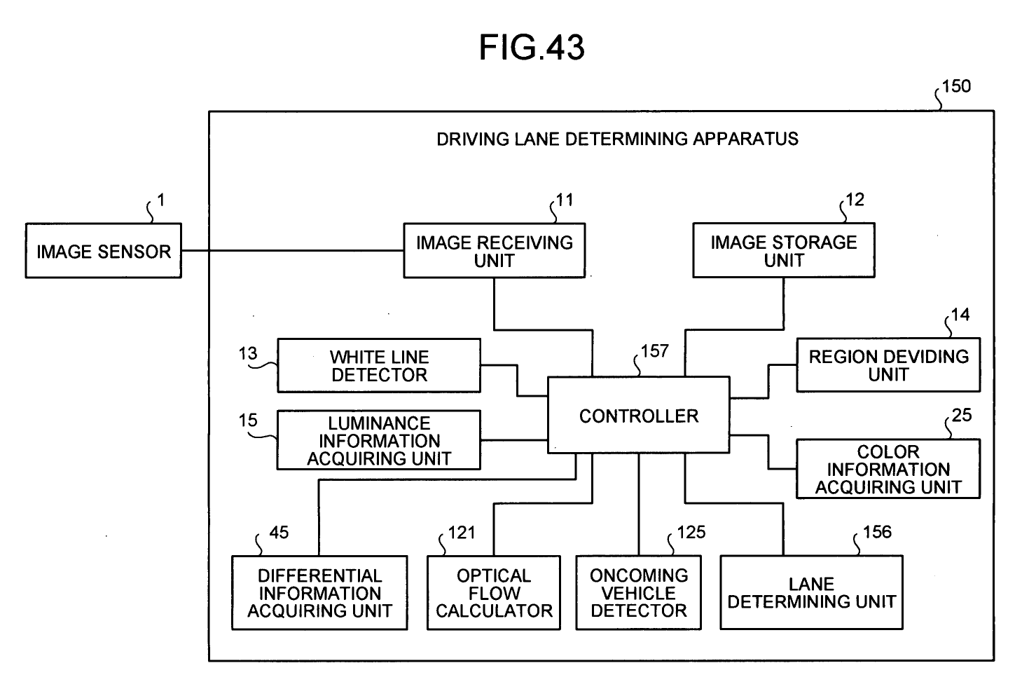

FIG. 43 is a functional block diagram of a driving lane determining apparatus 150 according to the fifteenth embodiment. For convenience, the functional units performing like roles as those of the respective units shown in FIG. 21 or 31 are designated by like reference signs, and the detailed explanation thereof is omitted.

The driving lane determining apparatus 150 includes the image receiving unit 11, the image storage unit 12, the white line detector 13, the region dividing unit 14, the luminance information acquiring unit 15, the color information acquiring unit 25, the differential information acquiring unit 45, the optical flow calculator 121, the oncoming vehicle detector 125, a lane determining unit 156, and a controller 157 that controls the whole driving lane determining apparatus 150.

That is, the driving lane determining apparatus 150 determines the shoulder of the road by using the information of the luminance, the color, and the derivative, to determine the driving lane, and also uses the information of the oncoming vehicle to determine the driving lane.

The lane determining unit 156 determines the driving lane by using the shoulder information and the information of the oncoming vehicle. By combining the shoulder information and the information of the oncoming vehicle and using the information for the determination of the driving lane, the lane determining unit 156 can perform accurate determination, even when adequate determination cannot be performed with the individual information.

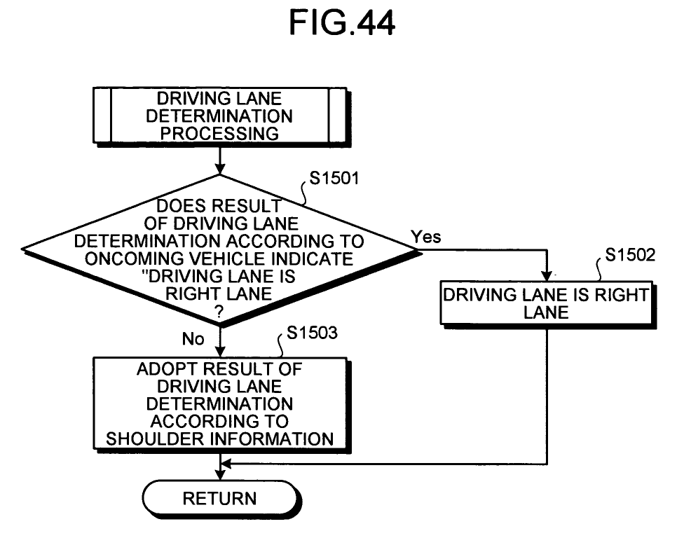

A driving lane determination processing performed by the lane determining unit 156 will be explained with reference to FIG. 44. The lane determining unit 156 performs the determination of the driving lane according to the oncoming vehicle, and determines whether the result indicates that “the driving lane is the right lane” (step S1501).

When the determination result according to the oncoming vehicle indicates that “the driving lane is the right lane”, the lane determining unit 156 adopts the determination result thereof as the driving lane determination result (step S1502). When the determination result according to the oncoming vehicle does not indicate that “the driving lane is the right lane”, the lane determining unit 156 performs the determination of the driving lane according to the shoulder information shown in the seventh embodiment, and adopts the result thereof as the driving lane determination result (step S1503).

Thus, the lane determining unit 156 preferentially adopts the determination according to the oncoming vehicle, and when the oncoming vehicle is not there, determines the driving lane by using the shoulder information. As a result, even if the oncoming vehicle does not exist, the driving lane determination can be performed.

An example in which the information of the color, the luminance, and the differential is used when determining the shoulder of the road has been explained. However, a part of the information may be used to determine the shoulder of the road. Moreover, the frequency information may be used with other pieces of the information, to perform the determination.

In the fifteenth embodiment, by combining the determination of the driving lane according to the oncoming vehicle and the determination thereof according to the shoulder information, the driving lane can be determined more accurately.

In the fifteenth embodiment, the driving lane determining apparatus that combines the shoulder information and the information of the oncoming vehicle to perform the determination has been explained. However, the information of the adjacent parallel vehicle may be used, instead of the information of the oncoming vehicle. In a sixteenth embodiment, a driving lane determining apparatus that combines the shoulder information and the information of the adjacent parallel vehicle to perform the determination will be explained.

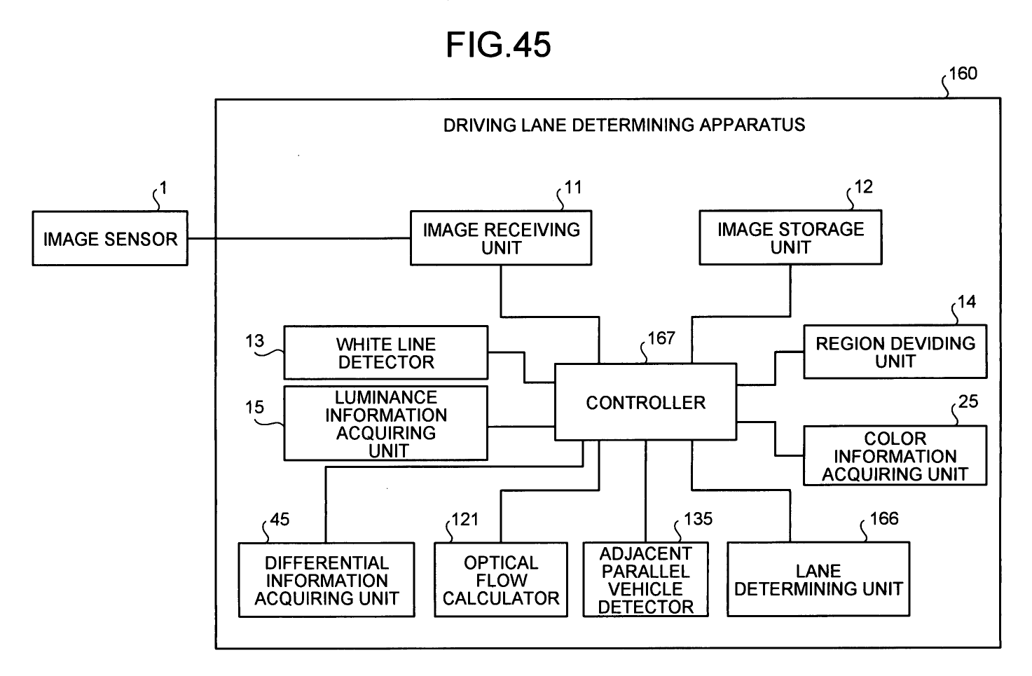

FIG. 45 is a functional block diagram of a driving lane determining apparatus 160 according to the sixteenth embodiment. The driving lane determining apparatus 160 includes the image receiving unit 11, the image storage unit 12, the white line detector 13, the region dividing unit 14, the luminance information acquiring unit 15, the color information acquiring unit 25, the differential information acquiring unit 45, the optical flow calculator 121, the adjacent parallel vehicle detector 135, a lane determining unit 166, and a controller 167 that controls the whole driving lane determining apparatus 160.

That is, the driving lane determining apparatus 160 determines the shoulder of the road by using the information of the luminance, the color, and the derivative, to determine the driving lane, and also uses the information of the adjacent parallel vehicle to determine the driving lane.

The lane determining unit 166 determines the driving lane by using the shoulder information and the information of the adjacent parallel vehicle. Specifically, the lane determining unit 166 gives priority to the determination according to the adjacent parallel vehicle, and when an adjacent parallel vehicle does not exist, adopts the determination result according to the shoulder information.

By combining the shoulder information and the information of the adjacent parallel vehicle and using the information for the determination of the driving lane, the lane determining unit 166 can perform accurate determination, even when adequate determination cannot be performed with the individual information.

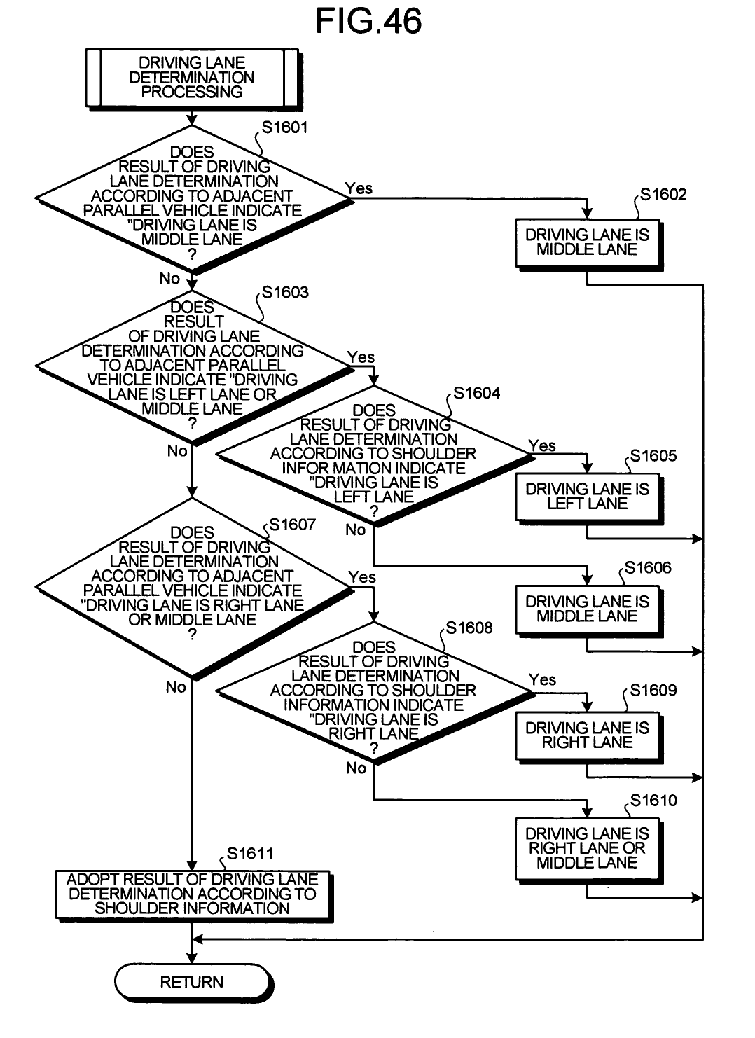

A driving lane determination processing performed by the lane determining unit 166 will be explained with reference to FIG. 46. The lane determining unit 166 performs the determination of the driving lane based on the adjacent parallel vehicle, and determines whether the result indicates that “the driving lane is the middle lane” (step S1601).

When the determination result according to the adjacent parallel vehicle indicates that “the driving lane is the middle lane”, the lane determining unit 166 adopts the determination result thereof as the driving lane determination result (step S1602). When the determination result according to the adjacent parallel vehicle does not indicate that “the driving lane is the middle lane”, the lane determining unit 166 determines whether the determination result according to the adjacent parallel vehicle indicates that “the driving lane is the left lane or the middle lane” (step S1603).

As a result, when the determination result according to the adjacent parallel vehicle indicates that “the driving lane is the left lane or the middle lane”, the lane determining unit 166 performs determination according to the shoulder information, to determine whether the result thereof indicates that “the driving lane is the left lane” (step S1604). When the determination result according to the shoulder information indicates that “the driving lane is the left lane”, the lane determining unit 166 adopts the result as the driving lane determination result (step S1605), and when the determination result according to the shoulder information does not indicate that “the driving lane is the left lane”, the lane determining unit 166 adopts the determination result indicating that “the driving lane is the middle lane” as the driving lane determination result (step S1606).

On the other hand, when the determination result according to the adjacent parallel vehicle does not indicate “the driving lane is the left lane or the middle lane”, the lane determining unit 166 determines whether the determination result according to the adjacent parallel vehicle indicates that “the driving lane is the right lane or the middle lane” (step S1607). When the determination result according to the adjacent parallel vehicle indicates that “the driving lane is the right lane or the middle lane”, the lane determining unit 166 performs the determination according to the shoulder information, to determine whether the result thereof indicates that “the driving lane is the right lane” (step S1608).

When the determination according to the shoulder information indicates that “the driving lane is the right lane”, the lane determining unit 166 adopts the result as the driving lane determination result (step S1609), and when the determination according to the shoulder information does not indicate that “the driving lane is the right lane”, adopts the result indicating that “the driving lane is the right lane or the middle lane” as the driving lane determination result (step S1610).

On the other hand, when the determination result according to the adjacent parallel vehicle does not indicate that “the driving lane is the right lane or the middle lane”, the lane determining unit 166 adopts the determination result according to the shoulder information as the driving lane determination result (step S1611).

Thus, the lane determining unit 166 preferentially adopts the determination according to the adjacent parallel vehicle, and when the adjacent parallel vehicle does not exist, determines the driving lane by using the shoulder information. As a result, even if the adjacent parallel vehicle does not exist, driving lane determination can be performed.

In the sixteenth embodiment, by combining the determination of the driving lane according to the adjacent parallel vehicle and the determination thereof according to the shoulder information, the driving lane can be determined more accurately.

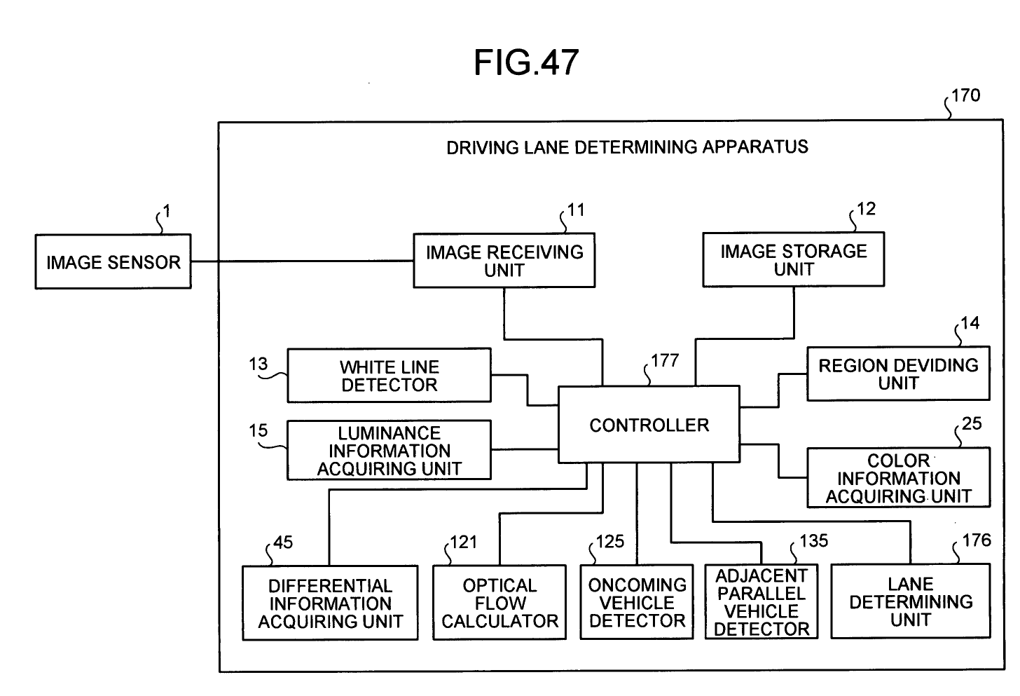

In the fifteenth embodiment, the driving lane determining apparatus that combines the shoulder information and the information of the oncoming vehicle to perform the determination has been explained. In the sixteenth embodiment, the driving lane determining apparatus that combines the shoulder information and the information of the adjacent parallel vehicle to perform the determination has been explained. On the contrary, the shoulder information, the information of the oncoming vehicle, and the information of the adjacent parallel vehicle may be combined. In a seventeenth embodiment, a driving lane determining apparatus that combines the shoulder information, the information of the oncoming vehicle, and the information of the adjacent parallel vehicle to perform determination will be explained. . FIG. 47 is a functional block diagram of a driving lane determining apparatus 170 according to the seventeenth embodiment. The driving lane determining apparatus 170 includes the image receiving unit 11, the image storage unit 12, the white line detector 13, the region dividing unit 14, the luminance information acquiring unit 15, the color information acquiring unit 25, the differential information acquiring unit 45, the optical flow calculator 121, the oncoming vehicle detector 125, the adjacent parallel vehicle detector 135, a lane determining unit 176, and a controller 177 that controls the whole driving lane determining apparatus 170.

That is, the driving lane determining apparatus 170 determines the shoulder of the road by using the information of the luminance, the color, and the differential, to determine the driving lane, and also uses the information of the oncoming vehicle and the adjacent parallel vehicle to determine the driving lane.

The lane determining unit 176 determines the driving lane by using the shoulder information, the information of the oncoming vehicle, and the information of the adjacent parallel vehicle. Specifically, the lane determining unit 176 gives priority to the determination according to the oncoming vehicle, and when an oncoming vehicle does not exist, adopts determination result according to the adjacent parallel vehicle, and when an adjacent parallel vehicle does not exist, adopts the determination result according to the shoulder information.

By combining the shoulder information and the information of the oncoming vehicle and the adjacent parallel vehicle, and using the information for determination of the driving lane, the lane determining unit 176 can perform accurate determination, even when adequate determination cannot be performed with the driving lane determination using the individual information.

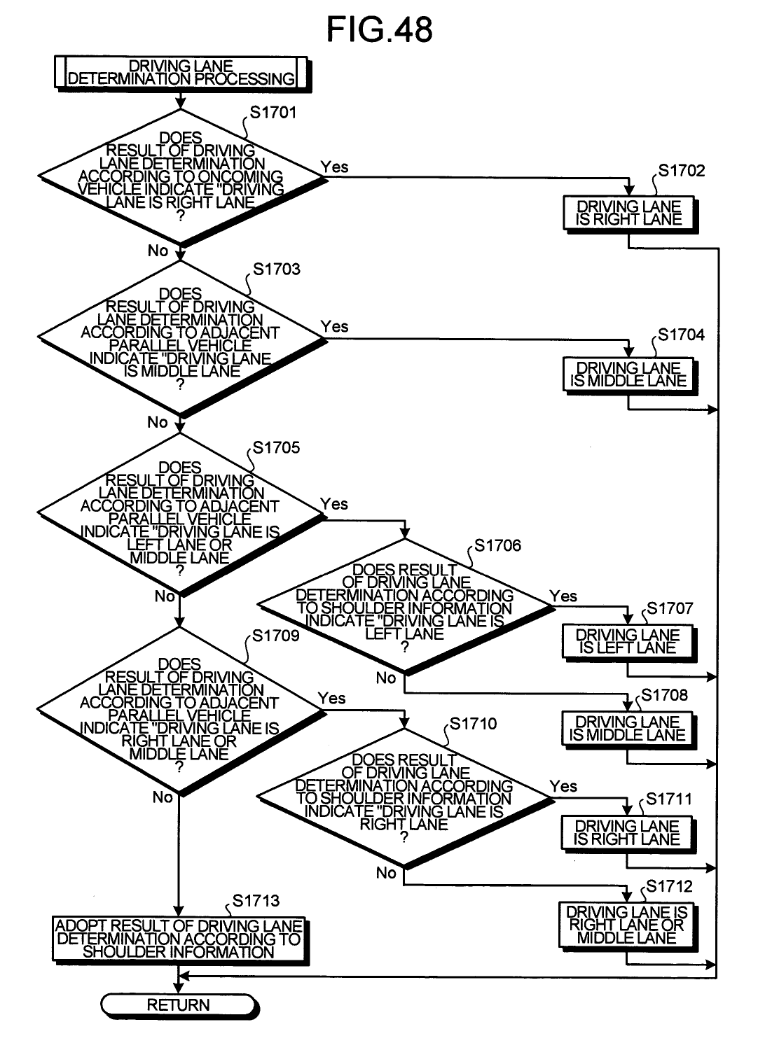

A driving lane determination processing performed by the lane determining unit 176 will be explained with reference to FIG. 48. The lane determining unit 176 performs the determination of the driving lane according to the oncoming vehicle, and determines whether the result indicates that “the driving lane is the right lane” (step S1701).

When the determination result according to the oncoming vehicle indicates that “the driving lane is the right lane”, the lane determining unit 176 adopts the determination result thereof as the driving lane determination result (step S1702). When the determination result according to the oncoming vehicle does not indicate that “the driving lane is the right lane”, the lane determining unit 176 performs the determination according to the adjacent parallel vehicle, to determine whether the determination result thereof indicates that “the driving lane is the middle lane” (step S1703).

When the determination result according to the adjacent parallel vehicle indicates that “the driving lane is the middle lane”, the lane determining unit 176 adopts the determination result thereof as the driving lane determination result (step S1704). When the determination result according to the adjacent parallel vehicle does not indicate that “the driving lane is the middle lane”, the lane determining unit 176 determines whether the determination result according to the adjacent parallel vehicle indicates that “the driving lane is the left lane or the middle lane” (step S1705).

As a result, when the determination result according to the adjacent parallel vehicle indicates that “the driving lane is the left lane or the middle lane”, the lane determining unit 176 performs the determination according to the shoulder information, to determine whether the result thereof indicates that “the driving lane is the left lane” (step S1706). When the determination result according to the shoulder information indicates that “the driving lane is the left lane”, the lane determining unit 176 adopts the result as the driving lane determination result (step S1707), and when the determination result according to the shoulder information does not indicate that “the driving lane is the left lane”, the lane determining unit 176 adopts the determination result indicating that “the driving lane is the middle lane” as the driving lane determination result (step S1708).

On the other hand, when the determination result according to the adjacent parallel vehicle does not indicate “the driving lane is the left lane or the middle lane”, the lane determining unit 176 determines whether the determination result according to the adjacent parallel vehicle indicates that “the driving lane is the right lane or the middle lane” (step S1709). When the determination result according to the adjacent parallel vehicle indicates that “the driving lane is the right lane or the middle lane”, the lane determining unit 176 performs determination according to the shoulder information, to determine whether the result thereof indicates that “the driving lane is the right lane” (step S1710).

When the determination according to the shoulder information indicates that “the driving lane is the right lane”, the lane determining unit 176 adopts the result as the driving lane determination result (step S1711), and when the determination according to the shoulder information does not indicate that “the driving lane is the right lane”, adopts the result indicating that “the driving lane is the right lane or the middle lane” as the driving lane determination result (step S1712).

On the other hand, when the determination result according to adjacent parallel vehicle does not indicate that “the driving lane is the right lane or the middle lane”, the lane determining unit 176 adopts the determination result according to the shoulder information as the driving lane determination result (step S1713).

Thus, the lane determining unit 176 preferentially adopts the determination according to the oncoming vehicle, and when an oncoming vehicle does not exist, adopts determination according to the adjacent parallel vehicle. When an adjacent parallel vehicle does not exit, the lane determining unit 176 determines the driving lane by using the shoulder information. As a result, even if an oncoming vehicle and an adjacent parallel vehicle do not exist, the driving lane determination can be performed.

In the seventeenth embodiment, by combining determination of the driving lane according to the oncoming vehicle and the adjacent parallel vehicle, and determination thereof according to the shoulder information, the driving lane can be determined more accurately.

In the twelfth embodiment, an example in which the oncoming vehicle is detected by using the optical flow to determine the driving lane has been explained. However, the oncoming vehicle may be detected by using an amount of shift in the image and the optical flow. In an eighteenth embodiment, a driving lane determining apparatus that detects the oncoming vehicle by using an amount of shift in the image (shift amount) and the optical flow to determine the driving lane will be explained.

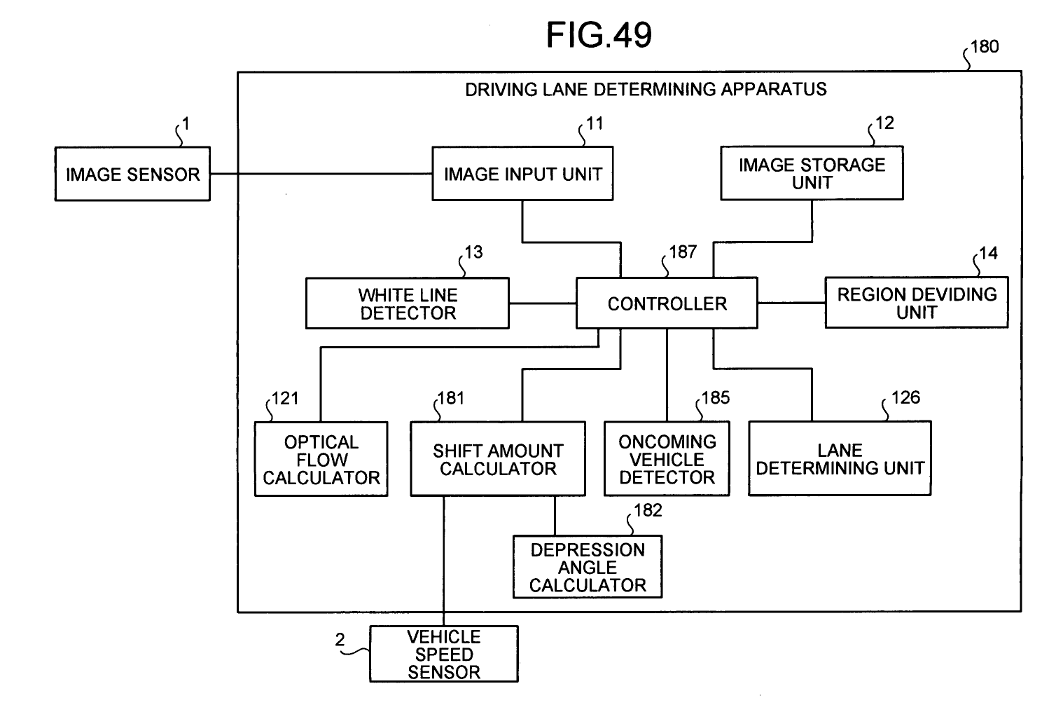

FIG. 49 is a functional block diagram of a driving lane determining apparatus 180 according to the eighteenth embodiment. For convenience, the functional units performing like roles as those of the respective units shown in FIG. 31 are designated by like reference signs, and the detailed explanation thereof is omitted.

The driving lane determining apparatus 180 includes the image receiving unit 11, the image storage unit 12, the white line detector 13, the region dividing unit 14, the optical flow calculator 121, a shift amount calculator 181, a depression angle calculator 182, an oncoming vehicle detector 185, the lane determining unit 126, and a controller 187 that controls the whole driving lane determining apparatus 180.

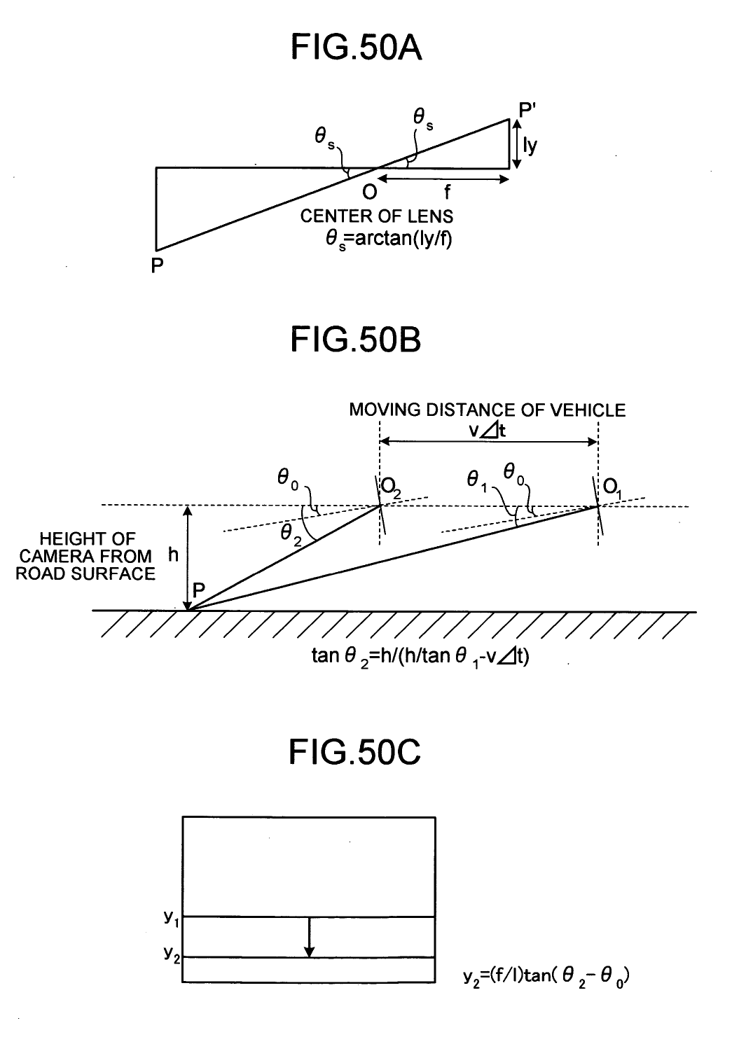

The shift amount calculator 181 calculates an amount of shift of a pixel in an image within a predetermined time by using an angle of depression. FIGS. 50A to 50C are views for explaining how the shift amount calculator 181 calculates the shift amount (shift amount calculation method).

When it is assumed that the coordinates of a pixel are (x, y), an angle θₛ between a pixel captured at the position of y and an optical axis of an image sensor 1 is, as shown in FIG. 50A, becomes θₛ=arctan(ly/f), where f is the focal length of the image sensor 1 and l is the photo detecting lattice size in the longitudinal direction (y-axis direction) of the image. Therefore, when it is assumed that the angle of depression when installing the image sensor 1 is θ₀, an angle of depression of the pixel captured at the position of y becomes θ=θₛ+θ₀.

Moreover, when it is assumed that the center of a lens constituting the image sensor 1 moves from O₁ to O₂ in time Δₜ, as shown in FIG. 50B, and a predetermined pixel at a position of a coordinate y₁ in a first image shifts to a coordinate Y2 in a second image taken after time Δ₁, as shown in FIG. 50C, the shift amount calculator 181 calculates y₁-y₂ as the shift amount.

Specifically, when it is assumed that the image sensor 1 is installed at height h from the road surface, the angle of depression at the position of y₁ is θ₁, and the angle of depression at the position of y₂ is θ₂, tanθ₂=h/(h/tanθ₁-Δt), from FIG. 50B. Therefore, the shift amount calculator 181 calculates θ₁=arctan(ly₁/f) from y₁, to determine the angle of depression θ₁, and calculates tanθ₂=h/(h/tanθ₁-vΔt) from the obtained θ₁ to determine θ₂. By using y₂=(f/1)/tan(θ₂-θ₀), the shift amount calculator 181 calculates y₂ from θ₂, and a shift amount y₁-y₂ by using the calculated y₂. The vehicle speed v is detected by using a vehicle speed sensor 2 formed of a plurality of sensors installed at the wheels.

The depression angle calculator 182 calculates the angle of depression used to calculate the shift amount by the shift amount calculator 181. That is, the depression angle calculator 182 calculates θₛ=arctan(ly/f) from the coordinate y, and calculates the angle of depression θ=θₛ+θ₀ from the calculated θₛ.

The oncoming vehicle detector 185 detects the oncoming vehicle by using the optical flows calculated by the optical flow calculator 121, and the shift amount calculated by the shift amount calculator 181.

Specifically, the oncoming vehicle detector 185 compares the shift amount calculated by the shift amount calculator 181 with the y components in the optical flow in the region of “label 2”, and when the y components in the optical flow in the region of “label 2” is larger than the shift amount, and the difference thereof is not smaller than a predetermined threshold, the oncoming vehicle detector 185 determines that there is an oncoming vehicle in the region of “label 2”.

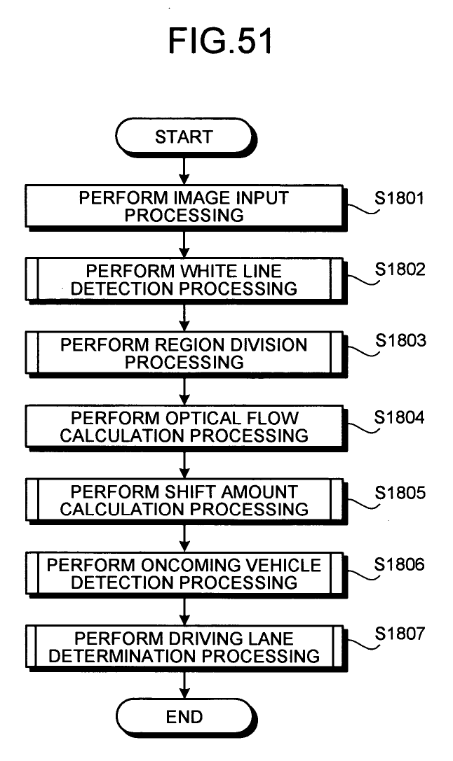

A process procedure performed by the driving lane determining apparatus 180 will be explained. FIG. 51 is a flowchart of the process procedure performed by the driving lane determining apparatus 180. The driving lane determining apparatus 180 performs image input processing in which the image receiving unit 11 receives the image information from the image sensor 1 and stores the information in the image storage unit 12 (step S1801, image input processing).

The white line detector 13 then uses the image information stored in the image storage unit 12 to detect two white lines (step S1802, white line detection processing), and the region dividing unit 14 divides a predetermined image area into three regions by using the two white lines detected by the white line detector 13 (step S1803, region division processing).

The optical flow calculator 121 calculates the optical flows in the respective regions divided into three by the region dividing unit 14 (step S1804, optical flow calculation processing), and the shift amount calculator 181 calculates the shift amount on the image by using the depression angle calculator 182 (step S1805, shift amount calculation processing).

The optical flow calculator 121 here calculates the optical flows, and then the shift amount calculator 181 calculates the shift amount on the image. However, calculation of the shift amount by the shift amount calculator 181 may be carried out in parallel with the processing at steps S1801 to 1804.

The oncoming vehicle detector 185 detects an oncoming vehicle in the right lane by a comparison between the optical flow in the region of “label 2” calculated by the optical flow calculator 121 and the shift amount calculated by the shift amount calculator 181 (step S1806, oncoming vehicle detection processing). The lane determining unit 126 then determines the driving lane by using the oncoming vehicle detection result obtained from the oncoming vehicle detector 185 (step S1807, driving lane determination processing).

In this manner, when there is an oncoming vehicle, the oncoming vehicle detector 185 detects the oncoming vehicle according to the optical flow and the shift amount, and hence, the driving lane determining apparatus 180 can specify the driving lane as the right lane.

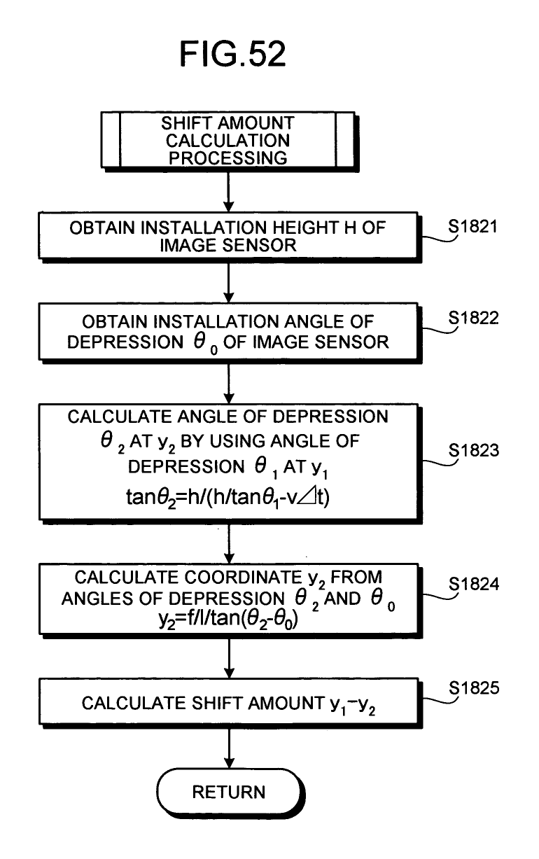

The shift amount calculation processing (step S1805) will be explained with reference to FIG. 52. The shift amount calculation processing is performed by the shift amount calculator 181.

In the shift amount calculation processing, the shift amount calculator 181 obtains the installation height h of the image sensor 1 and the installation angle of depression θ₀ (steps S1821 to 1822), and calculates the angle of depression θ₁ at the position of y₁ by using the angle of the depression θ₁ calculated by the depression angle calculator 182, to calculate the angle of depression θ₂ (step S1823). From the angles of the depression θ₂ and θ₀, the shift amount calculator 181 calculates y₂ (step S1824), and calculates the shift amount y₁-y₂ by using the calculated y₂ (step S1825).

In this manner, the driving lane determining apparatus 180 can detect the oncoming vehicle by using the optical flows and the shift amount by calculating the shift amount on the image by using the angle of depression in the shift amount calculation processing.

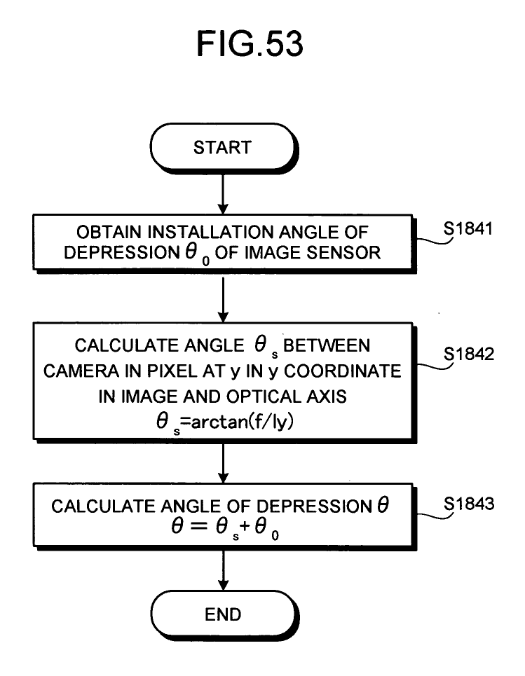

A depression angle calculation processing performed by the depression angle calculator 182 will be explained with reference to FIG. 53.

The depression angle calculator 182 obtains the installation angle of the depression θ₀ of the image sensor 1 (step S1841) and calculates the angle θₛ between a camera in a pixel at y in the y coordinate in the image and the optical axis (step S1842), and then calculates the angle of the depression θ by adding θₛ and θ₀ (step S1843).

Thus, since the depression angle calculator 182 calculates the angle of the depression from the y coordinate in the image, the driving lane determining apparatus 180 calculates the shift amount on the image, and can detect the oncoming vehicle by using the calculated shift amount and the optical flows.

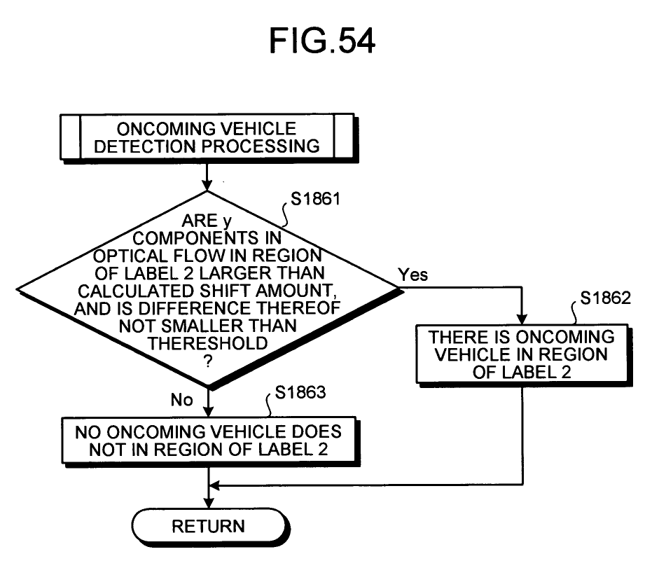

The oncoming vehicle detection processing (step S1806) will be explained with reference to FIG. 54. The oncoming vehicle detection processing is performed by the oncoming vehicle detector 185.

In the oncoming vehicle detection processing, the oncoming vehicle detector 185 determines whether the y components in the optical flow in the region of “label 2” are larger than the shift amount calculated by the shift amount calculator 181, and the difference is not smaller than the threshold (step S1861).

As a result, when the y components in the optical flow in the region of “label 2” are larger than the shift amount calculated by the shift amount calculator 181, and the difference is not smaller than the threshold, the oncoming vehicle detector 185 determines that there is an oncoming vehicle in the region of “label 2” (step S1862), and in other cases, determines that there is no oncoming vehicle in the region of “label 2” (step S1863).

In the oncoming vehicle detection processing, by comparing the shift amount calculated by the shift amount calculator 181 with the y components in the optical flow in the region of “label 2”, the oncoming vehicle in the right lane can be detected.

In the eighteenth embodiment, the shift amount calculator 181 calculates the shift amount on the image, the oncoming vehicle detector 185 detects the oncoming vehicle by using the y components in the optical flow calculated by the optical flow calculator 121 and the shift amount calculated by the shift amount calculator 181, and the lane determining unit 126 specifies the driving lane as the right lane, when the oncoming vehicle detector 185 detects the oncoming vehicle in the right region. As a result, the driving lane can be identified as the right lane, regardless of the lane line being a solid line or a broken line.

In the eighteenth embodiment, an example in which the oncoming vehicle is detected has been explained. However, the adjacent parallel vehicle may be detected. In a nineteenth embodiment, a driving lane determining apparatus that detects the adjacent parallel vehicle will be explained.

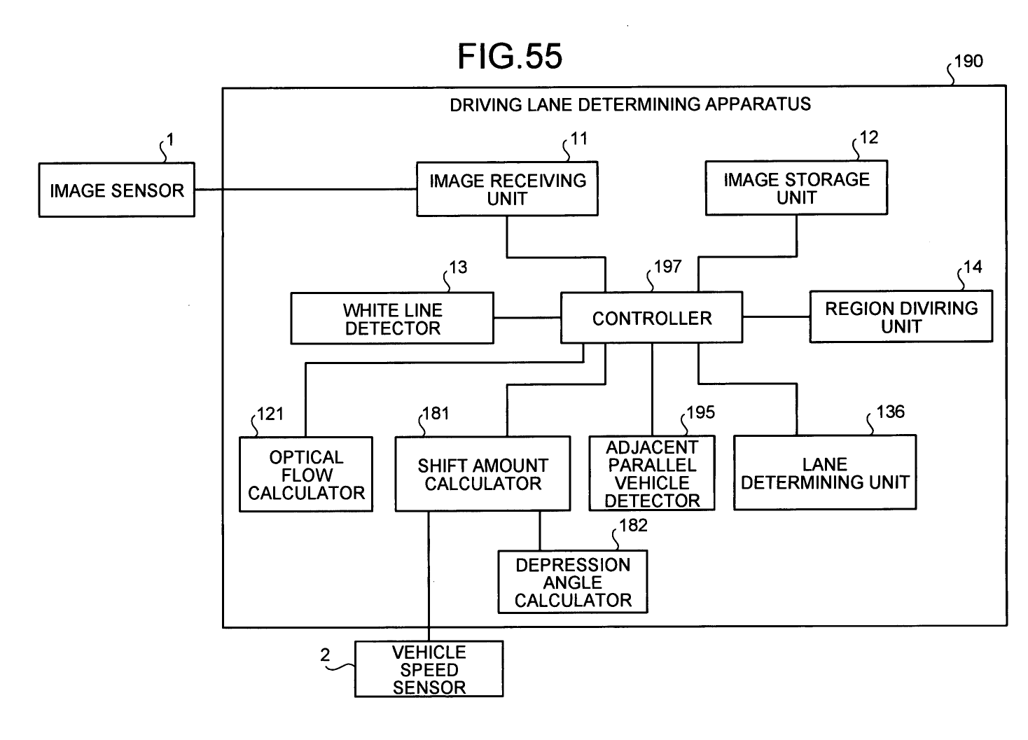

FIG. 55 is a functional block diagram of a driving lane determining apparatus 190 according to the nineteenth embodiment. For convenience, the functional units performing like roles as those of the respective units shown in FIG. 49 are designated by like reference signs, and the detailed explanation thereof is omitted.

The driving lane determining apparatus 190 includes the image receiving unit 11, the image storage unit 12, the white line detector 13, the region dividing unit 14, the optical flow calculator 121, the shift amount calculator 181, the depression angle calculator 182, an adjacent parallel vehicle detector 195, the lane determining unit 136, and a controller 197 that controls the whole driving lane determining apparatus 190.

The adjacent parallel vehicle detector 195 uses the optical flows calculated by the optical flow calculator 121 and the shift amount calculated by the shift amount calculator 181, to detect the adjacent parallel vehicle.

Specifically, the adjacent parallel vehicle detector 195 compares the shift amount calculated by the shift amount calculator 181 with the y components in the optical flow in the region of “label 2”, and when the y components in the optical flow in the region of “label 2” is smaller than the shift amount, and the difference thereof is not smaller than a predetermined threshold, the adjacent parallel vehicle detector 195 determines that there is an adjacent parallel vehicle in the region of “label 2”.

Moreover, the adjacent parallel vehicle detector 195 compares the shift amount calculated by the shift amount calculator 181 with the y components in the optical flow in the region of “label 3”, and when the y components in the optical flow in the region of “label 3” is smaller than the shift amount, and the difference thereof is not smaller than a predetermined threshold, the adjacent parallel vehicle detector 195 detects that there is an adjacent parallel vehicle in the region of “label 3”.

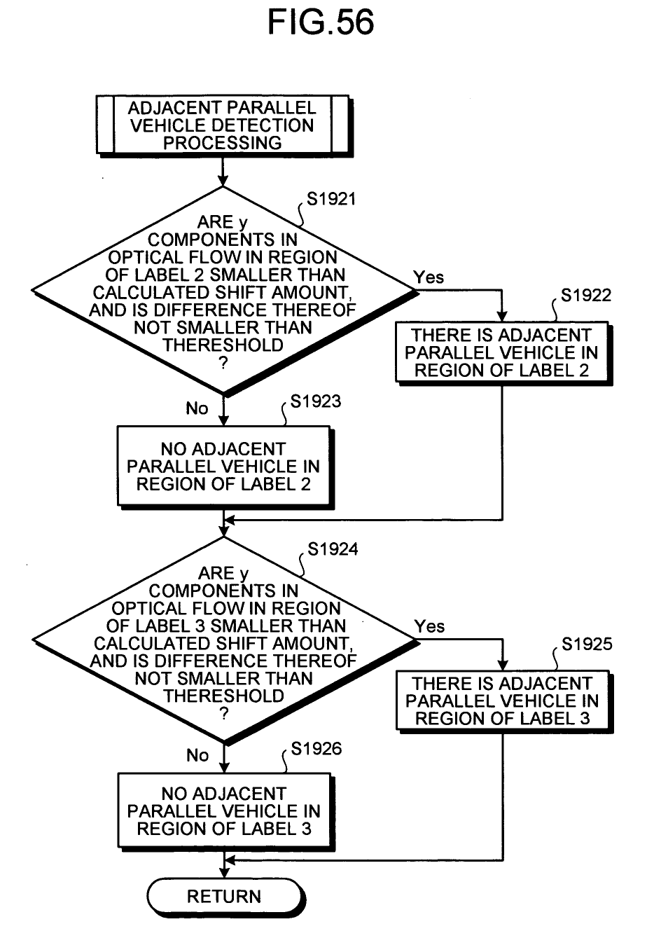

An adjacent parallel vehicle detection processing performed by the adjacent parallel vehicle detector 195 will be explained with reference to FIG. 56. In the adjacent parallel vehicle detection processing, the adjacent parallel vehicle detector 195 determines whether the y components in the optical flow in the region of “label 2” are smaller than the shift amount calculated by the shift amount calculator 181, and the difference thereof is not smaller than the threshold (step S1921).

As a result, when the y components in the optical flow in the region of “label 2” are smaller than the shift amount calculated by the shift amount calculator 181, and the difference thereof is not smaller than the threshold, the adjacent parallel vehicle detector 195 determines that there is an adjacent parallel vehicle in the region of “label 2” (step S1922), and in other cases, determines that there is no adjacent parallel vehicle in the region of “label 2” (step S1923).

The adjacent parallel vehicle detector 195 then determines whether the y components in the optical flow in the region of “label 3” are smaller than the shift amount calculated by the shift amount calculator 181, and the difference thereof is not smaller than the threshold (step S1924).

As a result, when the y components in the optical flow in the region of “label 3” are smaller than the shift amount calculated by the shift amount calculator 181, and the difference thereof is not smaller than the threshold, the adjacent parallel vehicle detector 195 determines that there is an adjacent parallel vehicle in the region of “label 3” (step S1925), and in other cases, determines that there is no adjacent parallel vehicle in the region of “label 3” (step S1926).

In the adjacent parallel vehicle detection processing, by comparing the shift amount calculated by the shift amount calculator 181 with the y components in the optical flow in the regions of “label 2” and “label 3”, the adjacent parallel vehicle can be detected.

In the nineteenth embodiment, the shift amount calculator 181 calculates the shift amount on the image, the adjacent parallel vehicle detector 195 detects the adjacent parallel vehicle by using the y components in the optical flow calculated by the optical flow calculator 121 and the shift amount calculated by the shift amount calculator 181, and the lane determining unit 136 determines the driving lane by using the information of the adjacent parallel vehicle detected by the adjacent parallel vehicle detector 195. As a result, the driving lane can be determined, regardless of the lane line being a solid line or a broken line.

In the first to the nineteenth embodiments, several examples in which the driving lane is determined by combining the luminance information, the color information, the differential information, the frequency information, the oncoming vehicle information, and the adjacent parallel vehicle information have been explained. However, the present invention is not limited thereto, and is applicable as well to an instance in which the driving lane is determined by other combinations.

In the first to the nineteenth embodiments, the driving lane determining apparatus has been explained. However, by realizing the configuration of the driving lane determining apparatus by software, a driving lane determination program having the same functions can be obtained. Therefore, a computer that executes the driving lane determination program will be explained here.

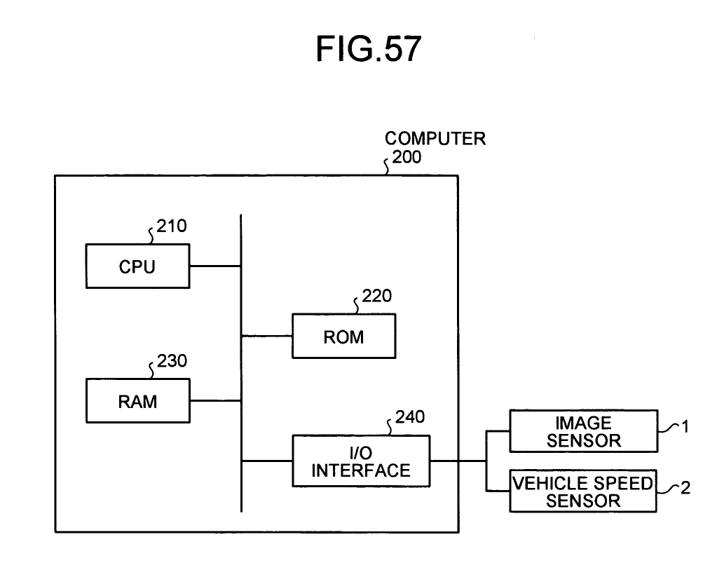

FIG. 57 is a hardware configuration of a computer that executes the driving lane determination program according to the first to the nineteenth embodiments. The computer 200 includes a central processing unit (CPU) 210, a read only memory (ROM) 220, a random access memory (RAM) 230, and an I/O interface 240.

The CPU 210 is a processor that executes the driving lane determination program, and the ROM 220 is a memory that stores the driving lane determination program and the like. The RAM 230 is a memory that stores data stored in the image storage unit 12 and interim results of execution of the driving lane determination program. The I/O interface 240 is an interface that receives data from the image sensor 1 and the vehicle speed sensor 2.

According to the present invention, the driving lane in which the own vehicle is running can be accurately determined.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer program that makes a computer execute:
detecting a lane line on a road on which a vehicle is running by using an image captured by an image sensor mounted on the vehicle;
dividing the image into a plurality of regions based on the lane line detected; and
determining a lane in which the vehicle is running based on characteristics of the image in the regions.

2. The computer program according to claim 1, wherein the characteristics include luminance information of the image.

3. The computer program according to claim 1, wherein the characteristics include color information of the image.

4. The computer program according to claim 1, wherein the characteristics include differential information of the image.

5. The computer program according to claim 1, further comprising determining an oncoming vehicle based on an optical flow in the regions, wherein
the determining a lane includes determining the lane based on a result of detection of the oncoming vehicle at the determining an oncoming vehicle.

6. The computer program according to claim 1, further comprising determining an adjacent parallel vehicle based on the optical flow in the regions, wherein
the determining a lane includes determining the lane based on a result of detection of the adjacent parallel vehicle at the determining an adjacent parallel vehicle.

7. The computer program according to claim 5, wherein the determining an oncoming vehicle includes determining the oncoming vehicle based on an amount of shift of a predetermined portion in an image due to a relative movement of the vehicle and the oncoming vehicle.

8. The computer program according to claim 6, wherein the determining an adjacent parallel vehicle includes determining the adjacent parallel vehicle based on an amount of shift of a predetermined portion in an image due to a relative movement of the vehicle and the adjacent parallel vehicle.

9. The computer program according to claim 1, wherein the characteristics include frequency information of the image.

10. The computer program according to claim 9, wherein the frequency information of the image is obtained by discrete Fourier transform of image data that make the image.

11. A computer-readable recording medium for storing a computer program that causes a computer to execute:
detecting a lane line on a road on which a vehicle is running by using an image captured by an image sensor mounted on the vehicle;
dividing the image into a plurality of regions based on the lane line detected; and
determining a lane in which the vehicle is running based on characteristics of the image in the regions.

12. A driving lane determining apparatus comprising:
a lane line detector that detects a lane line on a road on which a vehicle is running by using an image captured by an image sensor mounted on the vehicle;
a region dividing unit that divides the image into a plurality of regions based on the lane line detected; and
a driving lane determining unit that determines a lane in which the vehicle is running based on characteristics of the image in the regions.

13. The driving lane determining apparatus according to claim 12, wherein the characteristics include luminance information of the image.

14. The driving lane determining apparatus according to claim 12, wherein the characteristics include color information of the image.

15. The driving lane determining apparatus according to claim 12, wherein the characteristics include differential information of the image.

16. The driving lane determining apparatus according to claim 12, further comprising an oncoming vehicle determining unit that determines an oncoming vehicle based on an optical flow in the regions, wherein
the driving lane determining unit determines the lane based on result of detection of the oncoming vehicle by the oncoming vehicle determining unit.

17. The driving lane determining apparatus according to claim 12, further comprising an adjacent parallel vehicle determining unit that determines an adjacent parallel vehicle based on the optical flow in the regions, wherein
the driving lane determining unit determines the lane based on result of detection of the adjacent parallel vehicle by the oncoming vehicle determining unit.

18. The driving lane determining apparatus according to claim 15, wherein the oncoming vehicle determining unit determines the oncoming vehicle based on an amount of shift of an image due to a relative movement of the vehicle and the oncoming vehicle.

19. The driving lane determining apparatus according to claim 16, wherein the adjacent parallel vehicle determining unit determines the adjacent parallel vehicle based on an amount of shift of an image due to a relative movement of the vehicle and the adjacent parallel vehicle.

20. A driving lane determining method comprising:
detecting a lane line on a road on which a vehicle is running by using an image captured by an image sensor mounted on the vehicle;
dividing the image into a plurality of regions based on the lane line detected; and
determining a lane in which the vehicle is running based on characteristics of the image in the regions.
